(19) United States
(12) Patent Application Publication
(10) Pub. No.: US 2014/0378363 A1
(43) Pub. Date: Dec. 25, 2014

(54) SHAPED SOAP PRODUCTS WITH A REDUCED CONTENT OF FATTY ACID SOAPS

(71) Applicant: Henkel AG & Co. KGaA, Duesseldorf (DE)

(72) Inventors: Claus-Peter Thiessies, Duesseldorf (DE); Heike Schelges, Willich (DE); Bhupendra Pandurang Khedkar, Sion Mumbai (IN); Rashmin Joshi, Sion Mumbai (IN)

(21) Appl. No.: 14/479,495

(22) Filed: Sep. 8, 2014

Related U.S. Application Data
(63) Continuation of application No. PCT/EP2013/052455, filed on Feb. 7, 2013.

(30) Foreign Application Priority Data
Mar. 8, 2012 (DE) 10 2012 203 688.1

(51) Int. Cl. C11D 9/22; C11D 17/00

(52) U.S. Cl. CPC C11D 9/22; C11D 17/0047
USPC 510/151

(57) ABSTRACT

Bar soaps, with improved smoothness and elevated lime soap dispersancy, are distinguished by a reduced content of fatty acid soaps and nevertheless have improved smoothness and elevated lime soap dispersancy together with improved mushiness properties and sufficient hardness simultaneously combined with low abrasion and reduced cracking.

### FIELD OF THE INVENTION

The present invention generally relates to shaped soap products, for example bar soaps, with improved smoothness and elevated lime soap dispersancy, which are distinguished by a reduced content of fatty acid soaps and nevertheless have improved smoothness and elevated lime soap dispersancy together with improved mushiness properties and sufficient hardness simultaneously combined with low abrasion and reduced cracking.

### BACKGROUND OF THE INVENTION

Soap bars are today used less and less despite being very good cleaning products from an environmental standpoint. Sales of soap bars are declining even in typical soap markets such as the USA. This is due not only to the costs of soap bars, but also to changed consumer habits. The costs of soap bars are largely determined by raw materials costs. One aim when developing soap bars is accordingly to reduce raw materials costs. If this is to be achieved, the quantities of fatty acid soaps must in particular be reduced, but this is not straightforwardly possible. Today's soap compositions include a plurality of auxiliary and active substances to enable rapid production of soap bars in large numbers. At the same time, consumers expect that in particular properties such as lime soap dispersancy, tendency to mushiness when kept on the washbasin, yield and skin feel when cleaning with the soap bar are at least comparable to conventional soap bars.

One solution to the problem could be to reduce the content of fatty acids and triglycerides in the soap bars. At the same time, the content of fillers could be increased or be balanced by adding a proportion of liquid surfactants together with gel-forming substances.

In the past, however, these approaches have not proven feasible within the production process or considerable shortcomings in the service characteristics of such soap bars were encountered. For example, an elevated filler content results in smaller soap bars which in addition shrink further after production due to evaporation of water.

WO 2001/042418 and WO 2006/094586, for example, describe the use of amorphous alumina or inorganic aluminum silicates. U.S. Pat. No. 6,440,908 furthermore describes the use of borates as fillers. Finally, WO 98/18896, US 2007/0021314 and US 2007/0155639 describe increased use of starch and synthetic surfactants together with hydrocarbons, moisturizers and free fatty acid and mixtures thereof. Finally, GB 806340.6 describes soap bars with an elevated content of starch and specific selected polyols. None of the stated publications, however, discloses soap bars with a reduced content of fatty acid soaps which exhibit the service characteristics of conventional soaps. None of the proposed solutions is capable of simultaneously meeting the requirements for economically viable and inexpensive production as well as improved smoothness and elevated lime soap dispersancy together with improved mushiness properties and sufficient hardness simultaneously combined with low abrasion and reduced cracking with a reduced content of fatty acid soaps.

In view of the above deficiencies of the prior art, the desirable features and characteristics of the present invention will become apparent from the subsequent detailed description of the invention and the appended claims.

### BRIEF SUMMARY OF THE INVENTION

Soap bars including, in each case relative to the total weight of the soap bar, a) fatty acid soaps in a total quantity of 20 to 60 wt. %, preferably 30 to 60 wt. %, more preferably 30 to 55 wt. %, highly preferably 35 to 55 wt. % and in particular of 30 to 50 wt. %; b) talcum in a total quantity of 3 to 40 wt. %, preferably 5 to 35 wt. %, more preferably 10 to 35 wt. %, still more preferably 15 to 35 wt. %, highly preferably 15 to 30 wt. %; c) silicates in a total quantity of 0.5 to 30 wt. %, preferably 1.0 to 30 wt. %, still more preferably of 1.0 to 20.0 wt. % and highly preferably of 3.0 to 20.0 wt. %; d) synthetic surfactants, selected from anionic, amphoteric, zwitterionic, nonionic and/or cationic surfactants in a total quantity of 0.1 to 20.0 wt. %, preferably of 0.1 to 15.0 wt. %, more preferably 0.2 to 10.0 wt. %, still more preferably of 0.5 to 10.0 wt. %, highly preferably of 2.0 to 10.0 wt. % and in particular less than 8.0 wt. %; and e) starch in a total quantity of 0.1 to 10.0 wt. %, preferably of 0.5 to 10.0 wt. %, more preferably 1.0 to 8.0 wt. %, more preferably 2.0 to 8.0 wt. %, particularly preferably 2.0 to 5.0 wt. % and highly preferably less than 5.0 wt. %.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention. It has surprisingly now been found that it is possible to manufacture bar soaps which have a reduced content of fatty acid soaps and meet the above-stated requirements. The present application accordingly provides bar soaps with a reduced content of fatty acid soaps, including, in each case relative to the total weight of the soap bar,
a) fatty acid soaps in a total quantity of 20 to 60 wt. %, preferably 30 to 60 wt. %, more preferably 30 to 55 wt. %, highly preferably 35 to 55 wt. % and in particular of 30 to 50 wt. %,
b) talcum in a total quantity of 3 to 40 wt. %, preferably 5 to 35 wt. %, more preferably 10 to 35 wt. %, still more preferably 15 to 35 wt. %, highly preferably 15 to 30 wt. %,
c) silicates in a total quantity of 0.5 to 30 wt. %, preferably 1.0 to 30 wt. %, still more preferably of 1.0 to 20.0 wt. % and highly preferably of 3.0 to 20.0 wt. %,
d) synthetic surfactants, selected from anionic, amphoteric, zwitterionic, nonionic and/or cationic surfactants in a total quantity of 0.1 to 20.0 wt. %, preferably of 0.1 to 15.0 wt. %, more preferably 0.2 to 10.0 wt. %, still more preferably of 0.5 to 10.0 wt. %, highly preferably of 2.0 to 10.0 wt. % and in particular less than 8.0 wt. % and
e) starch in a total quantity of 0.1 to 10.0 wt. %, preferably of 0.5 to 10.0 wt. %, more preferably 1.0 to 8.0 wt. %, more preferably 2.0 to 8.0 wt. %, particularly preferably 2.0 to 5.0 wt. % and highly preferably less than 5.0 wt. %.

The shaped soap products according to the invention have a particularly smooth surface after mechanical shaping. In use, they produce a creamy, stable lather. The lime soap precipitate formed in hard water remains dispersed in the water and does not give rise to greasy gray deposits on the surface of sanitary ware.

The necessary ingredients of the soap bars are described below.

### Fatty Acid Soaps:

The sodium, potassium or ammonium salts of fatty acids are designated fatty acid soaps. Fatty acids which may be used are linear and/or branched, saturated and/or unsaturated fatty acids with 6-30 carbon atoms, for example caproic acid, caprylic acid, 2-ethylhexanoic acid, capric acid, lauric, myristic, palmitic, stearic, arachidic and behenic acid, erucic acid, isostearic acid, isotridecanoic acid as well as elaidic acid, petroselinic acid, elaeostearic acid, arachidic acid, gadoleic acid, palmitoleic, oleic, linoleic, linolenic, and arachidonic acid. Technical mixtures, as are obtainable from plant and animal fats and oils, for example coconut oil fatty acid and tallow fatty acid, are preferably used. Technical mixtures are also in particular referred to as “lauric soaps” with a preferred C chain length of C₁₂ to C₁₄ which is predominantly saturated. This preferably means that, due to technical factors, proportions of for example C₁₀ fatty acid may be present. “Stearic soaps” are another such fatty acid fraction. These preferably include C₁₆ to C₁₈ fatty acids which are preferably saturated. In this case too, shorter or longer fatty acids, for example C₂₀ fatty acids, may be present. Oleics are examples of technical unsaturated fatty acid soaps. Oleic soaps include unsaturated fatty acid soaps, preferably oleic acid (C18:1), linoleic acid soaps (C18:2) and myristoleic acid soap (C14:1) and palmitoleic acid (C16:1) as well as small proportions of longer and shorter saturated and unsaturated and polyunsaturated fatty acid soaps. Oleics are generally obtained from the hydrolysis of triglyceride oils of tallow, palm oil, sunflower oil and soy oil. Finally, “coconut oils” are also known. They are often replaced by “lauric-rich oils”. The latter include at least 45 wt. % of the entire fatty acids composed of lauric acid, myristic acid and mixtures thereof. Coconut oils are in particular obtained from tropical nuts from the class of coconut oils. These include for example palm kernel oil, babassu oil, ouricuri oil, tucum oil, cohune nut oil, murumuru oil, jaboty kernel oil, khakan kernel oil, dika nut oil and ucuhuba butter. Mixtures of coconut and tallow fatty acid cuts, in particular a mixture of 50-80 wt. % C₁₆-C₁₈ tallow fatty acid and 20-50 wt. % C₁₂-C₁₄ coconut fatty acid are more preferred.

Fatty acids with 10-22 carbon atoms are preferred.

The total quantity of fatty acid soaps amounts to 20 to 60 wt. %, relative to the total weight of the soap bar. The total quantity of fatty acid soaps preferably amounts to 30-60 wt. %, more preferably 30 to 55 wt. %, highly preferably 35 to 55 wt. % and in particular from 30 to 50 wt. %.

A certain content of free, unsaponified fatty acid in toilet soaps has applicational advantages, in particular forming a creamy lather with fine bubbles and a pleasant skin feel. Such soaps “superfatted” with free fatty acid soaps may be produced by using a slight deficit of alkali during saponification.

Soap bars according to the invention are therefore characterized in that, in relation to the total weight of the soap bar, they include 0.01 to 10.0 wt. %, preferably 0.1 to 8 wt. %, more preferably 0.5 to 8 wt. %, highly preferably 1.0 to 5.0 wt. % of free fatty acid.

### Talcum:

For the purposes of the invention, talcum is taken to mean a hydrated magnesium silicate of the theoretical composition 3MgO.4SiO₂.H₂O or Mg₃(Si₄O₁₀).(OH)₂ which may, however, include proportions of hydrated magnesium aluminum silicate of up to 12 wt. % Al₂O₃, relative to the entire product.

The particle diameter (equivalent spherical diameter) of the talcum should be in the range from 0.5-50 μm. In general, those grades of talcum which include no more than 5 wt. % of particles below 1 μm and no more than 5 wt. % of particle above 50 μm in size have proven successful. The proportion of particles which is larger than 40 μm in diameter (screen residue) is preferably at most 2 wt. %. The average particle diameter (D50) is preferably 5-15 μm.

The content of accompanying substances should amount to no more than 1.6 wt. % Fe₂O₃, 1 wt. % CaO and 1 wt. % of unbound water (drying loss at 105° C.). The content of hydrated magnesium aluminum silicate may be up to 60 wt. %, calculated as Al₂O₃, up to 12 wt. %.

Talcum is used in a quantity of 3 to 40 wt. %, preferably 5 to 35 wt. %, more preferably 10 to 35 wt. %, still more preferably 15 to 35 wt. %, highly preferably 15 to 30 wt. %.

### Silicates:

The soaps according to the invention include finely divided, water-insoluble alkali metal aluminum silicates as builders, wherein it is more preferred to use synthetic, crystalline sodium aluminosilicates including bound water and in particular zeolite A. Zeolite NaX and the mixtures thereof with zeolite NaA may likewise be used. Suitable zeolites have a calcium binding capacity in the range from 100 to 200 mg CaO/g, determined as specified in DE 24 12 837. The zeolite NaA obtainable under the trade name Wessalith P (Degussa) with a bound water content of approximately 20 wt. % is preferably used.

The silicates are used in a total quantity of 0.5 to 30 wt. %, preferably 1.0 to 30 wt. %, still more preferably from 1.0 to 20.0 wt. % and highly preferably from 3.0 to 20.0 wt. %.

More preferred soaps are those in which the talcum and the silicates are used in a ratio of 10:1 to 1:3, more preferably of 7:1 to 1:2, still more preferably of 6:1 to 1:2 and highly preferably of 5:1 to 2:1.

In addition to the talcum and silicates as a structure-imparting component, it is furthermore possible according to the invention for further inorganic substances to be usable for imparting structure. These substances include calcium carbonates such as calcite, aragonite and valerite, borates, kaolin, phosphates and sulfates. All the inorganic substances must have a particle size of less than 300 μm, preferably less than 100 μm, more preferably less than 50 μm and highly preferably less than 20 μm. This is particularly important so that the particles are not perceived as particles and cause a scratchy sensation during use.

In the event that these further inorganic compounds are used, the ratio between talcum and silicate of at least 5:1 to 2:1 must be maintained. In this case, talcum is used in a quantity of 10 to 35 wt. %, still more preferably 15 to 35 wt. %, highly preferably 15 to 30 wt. %.

In this case of using further inorganic substances, the silicate is used in a quantity of 1.0 to 20.0 wt. % and highly preferably of 3.0 to 20.0 wt. %.

### Synthetic Surfactants:

It has proven particularly advantageous to use surfactants for formulating soap bars with a strong cleaning action.

Anionic surfactants (Tanion) which are suitable in preparations according to the invention are any anionic surface-active substances suitable for use on the human body.

Typical examples of anionic surfactants are:
ether carboxylic acids of formula R—O—(CH₂—CH₂O)ₓ—CH₂—COOH, in which R is a linear alkyl group with 8 to 30 C atoms and x=0 or 1 to 16 and the salts thereof,
acyl sarcosides with 8 to 24 C atoms in the acyl group,
acyl taurides with 8 to 24 C atoms in the acyl group,
acyl isethionates with 8 to 24 C atoms in the acyl group,
sulfosuccinic acid mono- and dialkyl esters with 8 to 24 C atoms in the alkyl group and sulfosuccinic acid monoalkyl polyoxyethyl esters with 8 to 24 C atoms in the alkyl group and 1 to 6 oxyethyl groups,
linear alkane sulfonates with 8 to 24 C atoms,
linear alpha-olefin sulfonates with 8 to 24 C atoms, alpha-sulfofatty acid methyl esters of fatty acids with 8 to 30 C atoms,
alkyl sulfates and alkyl polyglycol ether sulfates of formula R—O(CH₂—CH₂O)ₓ—OSO₃H, in which R is a preferably linear alkyl group with 8 to 30 C atoms and x=0 or 1 to 12,
hydroxysulfonates substantially corresponding to at least one of the two following formulae or mixtures thereof and the salts thereof, CH₃—(CH₂)_{y}—CHOH—(CH₂)ₚ—(CH—SO₃M)-(CH₂)_{z}—CH₂—O—(CₙH₂ₙO)ₓ—H and/or CH₃—(CH₂)_{y}—(CH—SO₃M)-(CH₂)ₚ—CHOH—(CH₂)_{z}—CH₂—O—(CₙH₂O)ₓ—H wherein in both formulae y and z=0 or integers from 1 to 18, p=0, 1 or 2 and the sum (y+z+p) is a number from 12 to 18, x=0 or a number from 1 to 30 and n an integer from 2 to 4 and M=H or alkali metal, in particular sodium, potassium or lithium, alkaline earth metal, in particular magnesium, calcium or zinc, and/or an ammonium ion which may optionally be substituted, in particular mono-, di-, tri- or tetraammonium ions with C₁ to C₄ alkyl, alkenyl or aryl residues,
sulfated hydroxyalkyl polyethylene glycol ethers and/or hydroxyalkylene propylene glycol ethers of formula R¹—(CHOSO₃M)-CHR³—(OCHR⁴—CH₂)ₙ—OR² where R¹ is a linear alkyl residue with 1 to 24 C atoms, R² denotes a linear or branched, saturated alkyl residue with 1 to 24 C atoms, R³ denotes hydrogen or a linear alkyl residue with 1 to 24 C atoms, R⁴ denotes hydrogen or a methyl residue and M denotes hydrogen, ammonium, alkylammonium, alkanolammonium, in which the alkyl and alkanol residues in each case have 1 to 4 C atoms, or a metal atom selected from lithium, sodium, potassium, calcium or magnesium and n denotes a number in the range from 0 to 12 and furthermore the total number of C atoms present in R¹ and R³ amounts to 2 to 44, sulfonates of unsaturated fatty acids with 8 to 24 C atoms and 1 to 6 double bonds, esters of tartaric acid and citric acid with alcohols, which are addition products of approximately 2-15 molecules of ethylene oxide and/or propylene oxide onto fatty alcohols with 8 to 22 C atoms, alkyl and/or alkenyl ether phosphates of formula R¹(OCH₂CH₂)ₙ—O—(PO—OX)—OR², in which R¹ preferably denotes an aliphatic hydrocarbon residue with 8 to 30 carbon atoms, R² denotes hydrogen, a residue (CH₂CH₂O)ₙR² or X, n denotes numbers from 1 to 10 and X denotes hydrogen, an alkali metal or alkaline earth metal or NR³R⁴R⁵R⁶, with R³ to R⁶ mutually independently denoting hydrogen or a C₁ to C₄ hydrocarbon residue,
sulfated fatty acid alkylene glycol esters of formula RCO(AlkO)ₙSO₃M in which RCO denotes a linear or branched, aliphatic, saturated and/or unsaturated acyl residue with 6 to 22 C atoms, Alk denotes CH₂CH₂, CHCH₃CH₂ and/or CH₂CHCH₃, n denotes numbers from 0.5 to 5 and M denotes a metal, such as an alkali metal, in particular sodium, potassium or lithium, an alkaline earth metal, in particular magnesium, calcium or zinc, or an ammonium ion, such as ⁺NR³R⁴R⁵R⁶, with R³ to R⁶ mutually independently denoting hydrogen or a C₁ to C₄ hydrocarbon residue,
monoglyceride sulfates and monoglyceride ether sulfates of formula R⁸OC—(OCH₂CH₂)ₓ—OCH₂—[CHO(CH₂CH₂O)_{y}H]—CH₂O(CH₂CH₂O)_{z}—SO₃X, in which R⁸CO denotes a linear or branched acyl residue with 6 to 22 carbon atoms, x, y and z in sum denote 0 or numbers from 1 to 30, preferably 2 to 10, and X denotes an alkali metal or alkaline earth metal. Typical examples of monoglyceride (ether) sulfates suitable for the purposes of the invention are the reaction products of lauric acid monoglyceride, coconut fatty acid monoglyceride, palmitic acid monoglyceride, stearic acid monoglyceride, oleic acid monoglyceride and tallow fatty acid monoglyceride and the ethylene oxide addition products thereof with sulfur trioxide or chlorosulfonic acid in the form of the sodium salts thereof. Preferably, monoglyceride sulfates are used, in which R⁸CO denotes a linear acyl residue with 8 to 18 carbon atoms,
amide-ether carboxylic acids R¹—CO—NR²—CH₂CH₂—O—(CH₂CH₂O)ₙCH₂COOM, where R¹ is a straight-chain or branched alkyl or alkenyl residue with a number of carbon atoms in the chain of 2 to 30, n denotes an integer from 1 to 20 and R² denotes hydrogen, a methyl, ethyl, propyl, isopropyl, n-butyl, t-butyl or iso-butyl residue and M denotes hydrogen or a metal such as an alkali metal, in particular sodium, potassium or lithium, an alkaline earth metal, in particular magnesium, calcium or zinc, or an ammonium ion, such as ⁺NR³R⁴R⁵R⁶, with R³ to R⁶ mutually independently denoting hydrogen or a C₁ to C₄ hydrocarbon residue. Such products are obtainable for example from Chem-Y under the product name Akypo®.
acyl glutamates of formula XOOC—CH₂CH₂CH(C(NH)OR)—COOX, in which RCO denotes a linear or branched acyl residue with 6 to 22 carbon atoms and 0 and/or 1, 2 or 3 double bonds and X denotes hydrogen, an alkali metal and/or alkaline earth metal, ammonium, alkylammonium, alkanolammonium or glucammonium, condensation products of a water-soluble salt of a water-soluble protein hydrolysate with a C₈-C₃₀ fatty acid. Such products have long been commercially obtainable under the trademarks Lamepon®, Maypon®, Gluadin®, Hostapon® KCG or Amisoft®.
alkyl and/or alkenyl oligoglycoside carboxylates, sulfates, phosphates and/or isethionates,
acyl lactylates and
hydroxy mixed ether sulfates,
and mixtures thereof.

If the mild anionic surfactants include polyglycol ether chains, it is particularly preferable for them to exhibit a narrow homolog distribution. Furthermore, in the case of mild anionic surfactants with polyglycol ether units, it is preferred for the number of glycol ether groups to amount to 1 to 20, preferably 2 to 15, more preferably 2 to 12. Particularly mild anionic surfactants with polyglycol ether groups without a narrow homolog distribution may for example also be obtained if, on the one hand, the number of polyglycol ether groups amounts to 4 to 12 and Zn or Mg ions are selected as the counterion. One example of these is the commercial product Texapon® ASV.

More preferred soap bars are those including at least one anionic surfactant selected from:

acyl sarcosides with 8 to 24 C atoms in the acyl group,
ether carboxylic acids of formula R—O—(CH₂—CH₂O)ₓ—CH₂—COOH, in which R is a linear
alkyl group with 8 to 30 C atoms and x=0 or 1 to 16 and the salts thereof,
acyl taurides with 8 to 24 C atoms in the acyl group, acyl isethionates with 8 to 24 C atoms in the acyl group,
alkyl sulfates and alkyl polyglycol ether sulfates of formula R—O—(CH₂—CH₂O)ₓ—OSO₃H, in which R is a preferably linear alkyl group with 8 to 30 C atoms and x=0 or 1 to 12, alkyl and/or alkenyl ether phosphates of formula R¹(OCH₂CH₂)ₙ—O—(PO—OX)—OR², in which R¹ preferably denotes an aliphatic hydrocarbon residue with 8 to 30 carbon atoms, R² denotes hydrogen, a residue (CH₂CH₂O)ₙR² or X, n denotes numbers from 1 to 10 and X denotes hydrogen, an alkali metal or alkaline earth metal or NR³R⁴R⁵R⁶, with R³ to R⁶ mutually independently denoting hydrogen or a C₁ to C₄ hydrocarbon residue, monoglyceride sulfates and monoglyceride ether sulfates of formula R⁸OC—(OCH₂CH₂)ₓ—OCH₂—[CHO(CH₂CH₂O)_{y}H]-CH₂O(CH₂CH₂O)_{z}—SO₃X, in which R⁸CO denotes a linear or branched acyl residue with 6 to 22 carbon atoms, x, y and z in sum denote 0 or numbers from 1 to 30, preferably 2 to 10, and X denotes an alkali metal or alkaline earth metal. Typical examples of monoglyceride (ether) sulfates suitable for the purposes of the invention are the reaction products of lauric acid monoglyceride, coconut fatty acid monoglyceride, palmitic acid monoglyceride, stearic acid monoglyceride, oleic acid monoglyceride and tallow fatty acid monoglyceride and the ethylene oxide addition products thereof with sulfur trioxide or chlorosulfonic acid in the form of the sodium salts thereof. Preferably, monoglyceride sulfates are used, in which R⁸CO denotes a linear acyl residue with 8 to 18 carbon atoms,
acyl glutamates of formula XOOC—CH₂CH₂CH(C(NH)OR)—COOX, in which RCO denotes a linear or branched acyl residue with 6 to 22 carbon atoms and 0 and/or 1, 2 or 3 double bonds and X denotes hydrogen, an alkali metal and/or alkaline earth metal, ammonium, alkylammonium, alkanolammonium or glucammonium,
condensation products of a water-soluble salt of a water-soluble protein hydrolysate with a C₈-C₃₀ fatty acid, and mixtures thereof.

Particularly preferred soap bars are those including at least one anionic surfactant selected from:

alkyl sulfates and alkyl polyglycol ether sulfates of formula R—O—(CH₂—CH₂O)ₓ—OSO₃H, in which R is a preferably linear alkyl group with 8 to 30 C atoms and x=0 or 1 to 12, alkyl and/or alkenyl ether phosphates of formula R¹(OCH₂CH₂)ₙ—O—(PO—OX)—OR², in which R¹ preferably denotes an aliphatic hydrocarbon residue with 8 to 30 carbon atoms, R² denotes hydrogen, a residue (CH₂CH₂O)ₙR² or X, n denotes numbers from 1 to 10 and X denotes hydrogen, an alkali metal or alkaline earth metal or NR³R⁴R⁵R⁶, with R³ to R⁶ mutually independently denoting hydrogen or a C₁ to C₄ hydrocarbon residue,
acyl glutamates of formula XOOC—CH₂CH₂CH(C(NH)OR)—COOX, in which RCO denotes a linear or branched acyl residue with 6 to 22 carbon atoms and 0 and/or 1, 2 or 3 double bonds and X denotes hydrogen, an alkali metal and/or alkaline earth metal, ammonium, alkylammonium, alkanolammonium or glucammonium, and mixtures thereof.

Highly preferred soap bars are those including at least one anionic surfactant selected from: alkyl sulfates and alkyl polyglycol ether sulfates of formula R—O—(CH₂—CH₂O)ₓ—OSO₃H, in which R is a preferably linear alkyl group with 8 to 30 C atoms and x=0 or 1 to 12.

The anionic surfactants are used in a total quantity of 0.1 to 20.0 wt. %, preferably of 0.1 to 15.0 wt. %, more preferably 0.2 to 10.0 wt. %, still more preferably of 0.5 to 10.0 wt. %, highly preferably of 2.0 to 10.0 wt. % and in particular less than 8.0 wt. %.

Particularly suitable zwitterionic surfactants are “betaines” such as N-alkyl-N,N-dimethylammonium glycinates, for example cocoalkyldimethylammonium glycinate, N-acylaminopropyl-N,N-dimethylammonium glycinates, for example cocoacylaminopropyldimethylammonium glycinate, and 2-alkyl-3-carboxymethyl-3-hydroxyethylimidazolines with in each case 8 to 18 C atoms in the alkyl or acyl group and cocoacylaminoethylhydroxyethylcarboxymethyl glycinate. One preferred zwitterionic surfactant is the fatty acid amide derivative known by the INCI name Cocamidopropyl Betaine and Coco Betaine.

Ampholytic surfactants (Tampho) are taken to mean those surface-active compounds which are capable of forming internal salts. Examples of suitable ampholytic surfactants are N-alkylglycines, N-alkylpropionic acids, N-alkylaminobutyric acids, N-alkyliminodipropionic acids, N-hydroxyethyl-N-alkylamidopropylglycines, N-alkyltaurines, N-alkylsarcosines, 2-alkylaminopropionic acids and alkylaminoacetic acids with in each case approximately 8 to 24 C atoms in the alkyl group. Typical examples of amphoteric or zwitterionic surfactants are alkylbetaines, alkylamidobetaines, aminopropionates, aminoglycinates, imidazolinium betaines and sulfobetaines. Particularly preferred ampholytic surfactants are N-cocoalkyl aminopropionate, cocoacylaminoethyl aminopropionate and C₁₂₋₁₈ acyl sarcosine.

The amphoteric and zwitterionic surfactants are used in a total quantity of 0.1 to 20.0 wt. %, preferably of 0.1 to 15.0 wt. %, more preferably 0.2 to 10.0 wt. %, still more preferably of 0.5 to 10.0 wt. %, highly preferably of 2.0 to 10.0 wt. % and in particular less than 8.0 wt. %.

Nonionic surfactants (Tnio) are for example
addition products of 2 to 50 mol of ethylene oxide and/or 0 to 5 mol of propylene oxide onto linear and branched fatty alcohols with 6 to 30 C atoms, fatty alcohol polyglycol ethers or fatty alcohol polypropylene glycol ethers or mixed fatty alcohol polyethers,
addition products of 2 to 50 mol of ethylene oxide and/or 0 to 5 mol of propylene oxide onto linear and branched fatty acids with 6 to 30 C atoms, fatty acid polyglycol ethers or fatty acid polypropylene glycol ethers or mixed fatty acid polyethers,
addition products of 2 to 50 mol of ethylene oxide and/or 0 to 5 mol of propylene oxide onto linear and branched alkylphenols with 8 to 15 C atoms in the alkyl group, alkylphenolpolyglycol ethers or alkyl polypropylene glycol ethers, or mixed alkylphenol polyethers,
addition products, end group-terminated with a methyl or C₂-C₆ alkyl residue, of 2 to 50 mol of ethylene oxide and/or 0 to 5 mol of propylene oxide onto linear and branched fatty alcohols with 8 to 30 carbon atoms, onto fatty acids with 8 to 30 C atoms and onto alkylphenols with 8 to 15 C atoms in the alkyl group, such as for example the grades obtainable under the commercial names Dehydrol® LS, Dehydrol® LT (Cognis),
C₁₂-C₃₀ fatty acid mono- and diesters of addition products of 1 to 30 mol of ethylene oxide onto glycerol,
addition products of 5 to 60 mol of ethylene oxide onto castor oil and hardened castor oil,
polyol fatty acid esters, such as for example the commercial product Hydagen® HSP (Cognis) or Sovermol grades (Cognis), alkoxylated triglycerides,
alkoxylated fatty acid alkyl esters of formula (Tnio-1)

R¹CO—(OCH₂CHR²)_{w}OR³ (Tnio-1)
in which R′CO denotes a linear or branched, saturated and/or unsaturated acyl residue with 6 to 22 carbon atoms, R² denotes hydrogen or methyl, R³ denotes linear or branched alkyl residues with 1 to 4 carbon atoms and w denotes numbers from 1 to 20,
amine oxides,
hydroxy mixed ethers
   R¹O[CH₂CH(CH₃)O]ₓ(CH₂CHR²⁰)_{y}[CH₂CH(OH)R³]_{z} with R¹ denoting a linear or branched, saturated or unsaturated alkyl and/or alkenyl residue with 2 to 30 C atoms, R² denoting hydrogen, a methyl, ethyl, propyl or iso-propyl residue, R³ denoting a linear or branched alkyl residue with 2 to 30 C atoms, x denoting 0 or a number from 1 to 20, Y denoting a number from 1 to 30 and z denoting the number 1, 2, 3, 4 or 5.
sorbitan fatty acid esters and addition products of ethylene oxide onto sorbitan fatty acid esters such as for example polysorbates,
sugar fatty acid esters and addition products of ethylene oxide onto sugar fatty acid esters,
addition products of ethylene oxide onto fatty acid alkanolamides and fatty amines,
sugar surfactants of the alkyl and alkenyl oligoglycoside type,
sugar surfactants of the fatty acid N-alkyl polyhydroxyalkylamide type,
fatty acid amide polyglycol ethers, fatty amine polyglycol ethers,
mixed ethers or mixed formals
and mixtures thereof.

More preferred nonionic surfactants are the sorbitan fatty acid esters, alkyl- and alkenyloligoglucosides, for example the alkyl oligoglucoside with the INCI names Lauryl Glucoside, Decyl Glucoside, Coco Glucoside, fatty acid-N-alkylpolyhydroxyalkylamide and mixtures thereof.

The nonionic surfactants are used in a total quantity of 0.1 to 20.0 wt. %, preferably of 0.1 to 15.0 wt. %, more preferably 0.2 to 10.0 wt. %, still more preferably of 0.5 to 10.0 wt. %, highly preferably of 2.0 to 10.0 wt. % and in particular less than 8.0 wt. %.

Particularly preferred soap bars include at least one surfactant selected from anionic, amphoteric and/or zwitterionic and/or nonionic surfactants.

The respective surfactants are here highly preferably selected from preferred anionic, amphoteric and/or zwitterionic and/or nonionic surfactants.

The best results are achieved if at least one anionic surfactant in the soap bars according to the invention is selected from alkyl sulfates and alkyl polyglycol ether sulfates of formula R—O—(CH₂—CH₂O)ₓ—OSO₃H, in which R is a preferably linear alkyl group with 8 to 30 C atoms and x=0 or 1 to 12, and furthermore at least one of the amphoteric or zwitterionic surfactants Cocamidopropyl Betaine or Coco Betaine is present, and furthermore at least one nonionic surfactant selected from alkyl oligoglucosides is present.

In the above case, the anionic surfactant is used in a quantity of 0.5 to 10.0 wt. %, preferably of 2.0 to 6.0 wt. %, Cocamidopropyl Betaine or Coco Betaine in a quantity of 0.5 to 10.0 wt. %, preferably in a quantity of 0.5 to 6.0 wt. % and the alkyl oligoglucoside in a quantity of 0.1 to 6.0 wt. %, preferably in a quantity of 0.5 to 5.0 wt. %, in each case relative to the total weight of the soap bar. It goes without saying that in no event is either more or less of the total quantities of surfactants stated after the discussion of the cationic surfactants used.

Cationic surfactants may likewise be used as surfactants in the soap bars according to the invention. Examples of these are quaternary imidazoline compounds of formula I.

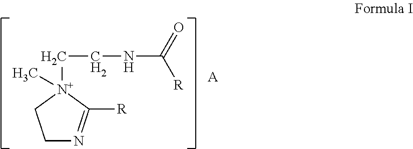

The residues R mutually independently in each case denote a saturated or unsaturated, linear or branched hydrocarbon residue with a chain length of 8 to 30 carbon atoms. The preferred compounds of formula I in each case include the same hydrocarbon residue for R. The chain length of the residues R preferably amounts to 12 to 21 carbon atoms.

Examples which are particularly according to the invention are obtainable for example under INCI names Quaternium-27, Quaternium-72, Quaternium-83 and Quaternium-91.

The following cationic surfactants according to formula (Tkat-2) may furthermore be used.

RCO—X—N⁺R¹R²R³A⁻ (Tkat-2)

R here denotes a substituted or unsubstituted, branched or straight-chain alkyl or alkenyl residue with 11 to 35 carbon atoms in the chain,
X denotes —O— or —NR⁵—,
R¹ denotes an alkylene group with 2 to 6 C atoms which may be unsubstituted or substituted, wherein in the case of substitution, substitution with an —OH or —NH group is preferred,
R², R³ in each case mutually independently denote an alkyl or hydroxyalkyl group with 1 up to 6 C atoms in the chain, wherein the chain may be linear or branched.
R⁵ denotes hydrogen or a C₁ to C₆ straight-chain or branched alkyl or alkenyl residue which may also be substituted by a hydroxyl group.

Within this structure class, the compounds of one of the following structures are preferably used:

CH₃(CH₂)₂₀CONH(CH₂)₃—N⁺(CH₃)₂—CH₂CH₃A⁻ (Tkat-3)

CH₃(CH₂)₂₀CONH(CH₂)₃—N⁺(CH₃)₂—CH₂(CHOH)CH₂OH A⁻ (Tkat-4)

CH₃(CH₂)₂₀COONH₂CHOHCH₂—N⁺(CH₃)₃A⁻ (Tkat-5)

CH₃(CH₂)₂₀CONH(CH₂)₃—N⁺(CH₃)₂—CH₂CH₂OH A⁻ (Tkat-6)

Examples of such commercial products are Schercoquat BAS, Lexquat AMG-BEO, Akypoquat 131 or Incroquat Behenyl HE.

Esterquats according to formula (Tkat1-2) may furthermore be used.

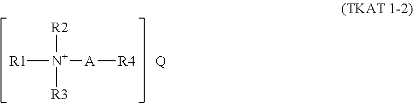

The residues R¹, R² and R³ are here in each case mutually independent and may be identical or different. The residues R¹, R² and R³ mean:
a branched or unbranched alkyl residue with 1 to 4 carbon atoms which may include at least one hydroxyl group, or
a saturated or unsaturated, branched or unbranched or a cyclic saturated or unsaturated alkyl residue with 6 to 30 carbon atoms which may include at least one hydroxyl group, or
an aryl or alkaryl residue, for example phenyl or benzyl,
the residue (-A-R⁴), providing that at most 2 of the residues R¹, R² or R³ may denote this residue.
   The residue -(A-R⁴) is present at least once to 3 times.
   A here denotes:
1) —(CH₂)ₙ— with n=1 to 20, preferably n=1 to 10 and more preferably n=1-5, or
2) —(CH₂—CHR⁵—O)ₙ— with n=1 to 200, preferably 1 to 100, more preferably 1 to 50, and more preferably 1 to 20 with R⁵ meaning hydrogen, methyl or ethyl, and R⁴ denotes:
1) R⁶—O—CO—, in which R⁶ is a saturated or unsaturated, branched or unbranched or a cyclic saturated or unsaturated alkyl residue with 6 to 30 carbon atoms which may include at least one hydroxyl group and which may optionally furthermore be ethoxylated with 1 to 100 ethylene oxide units and/or 1 to 100 propylene oxide units, or
2) R⁷—CO—, in which R⁷ is a saturated or unsaturated, branched or unbranched or a cyclic saturated or unsaturated alkyl residue with 6 to 30 carbon atoms which may include at least one hydroxyl group and which may optionally furthermore be ethoxylated with 1 to 100 ethylene oxide units and/or 1 to 100 propylene oxide units,
   and Q denotes a physiologically acceptable organic or inorganic anion.

Such products are sold, for example, under the trademarks Rewoquat®, Stepantex®, Dehyquart® and Armocare®. The products Armocare® VGH-70, an N,N-bis(2-palmitoyloxyethyl)dimethylammonium chloride, and Dehyquart® F-75, Dehyquart® C-4046, Dehyquart® L80, Dehyquart® F 30, Dehyquart® AU-35, Rewoquat® WE18, Rewoquat® WE38 DPG and Stepantex® VS 90 are examples of such esterquats.

Further compounds of formula (Tkat1-2) which are more preferred according to the invention belong to formula (Tkat1-2.1), the cationic betaine esters.

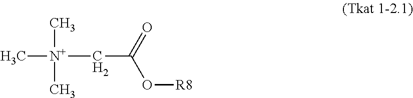

The meaning of R⁸ corresponds to that of R⁷.

Monoalkyltrimethylammonium salts with a chain length of the alkyl residue of 16 to 24 carbon atoms may be present as a further ingredient.

These compounds have the structure shown in formula (Tkat1-1),

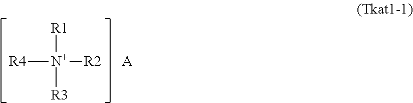

wherein R¹, R² and R³ in each case denote a methyl group and R⁴ denotes a saturated, branched or unbranched alkyl residue with a chain length of 16 to 24 carbon atoms. Examples of compounds of formula (Tkat1-1) are cetyltrimethylammonium chloride, cetyltrimethylammonium bromide, cetyltrimethylammonium methosulfate, stearyltrimethylammonium chloride, behenyltrimethylammonium chloride, behenyltrimethylammonium bromide and behenyltrimethylammonium methosulfate.

In a more preferred embodiment of the invention, the agents according to the invention furthermore include at least one amine and/or cationized amine, in particular an amidoamine and/or a cationized amidoamine with the following structural formulae:

R¹—NH—(CH₂)ₙ—NR²R³ (Tkat7) and/or

R¹—NH—(CH₂)ₙ—NR²R³R⁴ (Tkat8)

in which R¹ means an acyl or alkyl residue with 6 to 30 C atoms which may be branched or unbranched, saturated or unsaturated, and wherein the acyl residue and/or the alkyl residue may include at least one OH group, and
R², R³ and R⁴ in each case mutually independently mean hydrogen or an alkyl residue with 1 to 4 C atoms which may be identical or different, saturated or unsaturated, and
X⁻ means an anion and
n means an integer between 1 and 10.

A preferred composition is one in which the amine and/or the quaternized amine according to general formulae (Tkat7) and/or (Tkat8) is an amidoamine and/or a quaternized amidoamine, in which R¹ means a branched or unbranched, saturated or unsaturated acyl residue with 6 to 30 C atoms which may include at least one OH group. A fatty acid residue from oils and waxes, in particular from natural oils and waxes, is here preferred. Examples of the latter which may be considered are lanolin, beeswax or candelilla wax.

Preferred amidoamines and/or quaternized amidoamines are those in which R², R³ and/or R⁴ in formulae (Tkat7) and/or (Tkat8) mean a residue according to general formula CH₂CH₂OR⁵, in which R⁵ may have the meaning of alkyl residues with 1 to 4 carbon atoms, hydroxyethyl or hydrogen. The preferred size of n in the general formulae (Tkat7) and/or (Tkat8) is an integer between 2 and 5.

Furthermore preferred amidoamines and/or quaternized amidoamines of the general formulae (Tkat7) and/or (Tkat8) are those in which the anion X⁻ is a halide ion or a compound of the general formula RSO₃⁻, in which R has the meaning of saturated or unsaturated alkyl residues with 1 to 4 carbon atoms.

The alkyl residue with 1 to 4 carbon atoms of R², R³ and R⁴ and/or the alkyl residue with 1 to 4 carbon atoms of RSO₃⁻ in the general formulae (Tkat7) and/or (Tkat8) may include at least one hydroxyl group.

The alkylamidoamines may both be present as such and be converted into a quaternary compound in the composition by protonation in an appropriately acidic solution. Cationic alkylamidoamines are preferred according to the invention.

Examples of optionally quaternized amidoamines to be considered for use according to the invention are, as amidoamines: Witcamine 100 (Witco, INCI name: Cocamidopropyl Dimethylamine), Incromine BB (Croda, INCI name: Behenamidopropyl Dimethylamine), Mackine 401 (McIntyre, INCI name: Isostearylamidopropyl Dimethylamine) and other Mackine grades, Adogen S 18V (Witco, INCI name: Stearylamidopropyl Dimethylamine), and, as permanently cationic aminoamines: Rewoquat RTM 50 (Witco Surfactants GmbH, INCI name: Ricinoleamidopropyltrimonium Methosulfate), Empigen CSC (Albright & Wilson, INCI name: Cocamidopropyltrimonium Chloride), Swanol Lanoquat DES-50 (Nikko, INCI name: Quaternium-33), Rewoquat UTM 50 (Witco Surfactants GmbH, Undecyleneamidopropyltrimonium Methosulfate).

Finally, cationic surfactants of formula (Tkat1-1) may be used.

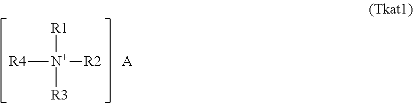

In the formula (Tkat1), R¹, R², R³ and R⁴ in each case mutually independently denote hydrogen, a methyl group, a phenyl group, a benzyl group, a saturated, branched or unbranched alkyl residue with a chain length of 8 to 30 carbon atoms which may optionally be substituted with one or more hydroxyl groups. A denotes a physiologically acceptable anion, for example halides such as chloride or bromide and methosulfates.

Examples of compounds of formula (Tkat1) are lauryltrimethylammonium chloride, cetyltrimethylammonium chloride, cetyltrimethylammonium bromide, cetyltrimethylammonium methosulfate, dicetyldimethylammonium chloride, tricetylmethylammonium chloride, stearyltrimethylammonium chloride, distearyldimethylammonium chloride, lauryldimethylbenzylammonium chloride, behenyltrimethylammonium chloride, behenyltrimethylammonium bromide, behenyltrimethylammonium methosulfate.

The anion of all the cationic compounds is selected from physiologically acceptable anions. Examples which may be mentioned by way of example are the halide ions, fluoride, chloride or bromide, sulfate of the general formula RSO₃⁻, in which R has the meaning of saturated or unsaturated alkyl residues with 1 to 4 carbon atoms, or anionic residues of organic acids such as maleate, fumarate, oxalate, tartrate, citrate, lactate or acetate.

The above-stated cationic surfactants may be used individually or in any desired combinations with one another, wherein quantities of between 0.01 and 20 wt. %, preferably quantities of 0.01 to 10 wt. % and particularly preferably quantities of 0.1 to 7.5 wt. % are present. The very best results are obtained with quantities of 0.1 to 5 wt. %, in each case relative to the total composition of the respective agent.

The surfactants are used in a total quantity of 0.1 to 20.0 wt. %, preferably of 0.1 to 15.0 wt. %, more preferably 0.2 to 10.0 wt. %, still more preferably of 0.5 to 10.0 wt. %, highly preferably of 2.0 to 10.0 wt. % and in particular less than 8.0 wt. %.

### Starch as Builder:

The bar soaps may include structuring agents such as polysaccharides as builders. Polysaccharides which are used are for example starch, preferably wheat or corn starch, potato starch, rice starch, starch from tapioca etc. and cellulose. Starch is more preferably used, it being possible to use it in untreated or in broken down, i.e. partially hydrolysed or acid-degraded form. Untreated starch has the advantage that it is present in the bar soaps in the form of small solid grains which have a gentle abrasive action in use and improve skin feel. Hydrolysed starch results in products with better shapeability and homogeneity. Mixtures of different starches may, of course, also be used. The starch may furthermore also be chemically modified.

Natural starch, i.e. an unmodified starch from a natural source is preferably used. These starches have different contents of amylose and amylopectin. Pregelatinized starch may be preferred according to the invention.

Preferred celluloses are microcrystalline celluloses.

Highly preferred polysaccharides are starch, in particular natural starch, pregelatinized starch and chemically modified starch and mixtures thereof.

The use of starch is a particularly critical variable. Starch makes the soap mass plastic. A certain degree of plasticity is advantageous for the soap production process. If, however, the soap mass becomes “rubber-elastic”, it is then no longer processable. It is therefore essential to avoid rubber-like behavior of the soap mass. The mass is then much too soft and sticky. The quantities of polysaccharides are therefore critical and must be complied with very precisely. According to the invention, starch is used in a total quantity of 0.1 to 10.0 wt. %, preferably of 0.5 to 10.0 wt. %, more preferably 1.0 to 8.0 wt. %, more preferably 2.0 to 8.0 wt. %, particularly preferably 2.0 to 5.0 wt. % and highly preferably less than 5.0 wt. %.

Further ingredients which may preferably be used for achieving specific additional properties, such as for example a deodorant action, or for improving the properties of the soap bars according to the invention are described below.

The soap bars according to the invention may include any substances known to act as plasticizers and binders. These are for example neutral fatty substances, preferably such from the group of fatty alcohols with 12-22 C atoms, of fatty acid glycerides of C₁₂-C₂₂ fatty acids or of fatty acid (C₁₂-C₂₂) fatty alcohol (C₁₂-C₂₂) esters.

Fatty alcohols (Fatal) which may be used are saturated, mono- or polyunsaturated, branched or unbranched fatty alcohols with C₆-C₃₀, preferably C₁₀-C₂₂ and more preferably C₁₂-C₂₂ carbon atoms. For the purposes of the invention, it is for example possible to use decanol, octanol, octenol, dodecenol, decenol, octadienol, dodecadienol, decadienol, oleyl alcohol, erucic alcohol, ricinol alcohol, stearyl alcohol, isostearyl alcohol, cetyl alcohol, lauryl alcohol, myristyl alcohol, arachidyl alcohol, caprylic alcohol, capric alcohol, linoleyl alcohol, linolenyl alcohol and behenyl alcohol, and the Guerbet alcohols thereof, wherein this list is intended to be of an exemplary and non-limiting nature. The fatty alcohols are, however, preferably derived from natural fatty acids, wherein the conventional starting point is isolation from the fatty acid esters by reduction. Fatty alcohol cuts which are a mixture of various fatty alcohols may likewise be used according to the invention. Such substances are commercially obtainable for example under the names Stenol®, for example Stenol® 1618 or Lanette®, for example Lanette® O or Lorol®, for example Lorol® C8, Lorol® C14, Lorol® C18, Lorol® C8-18, HD-Ocenol®, Crodacol®, for example Crodacol® CS, Novol®, Eutanol® G, Guerbitol® 16, Guerbitol® 18, Guerbitol® 20, Isofol® 12, Isofol® 16, Isofol® 24, Isofol® 36, Isocarb® 12, Isocarb® 16 or Isocarb® 24. Wool wax alcohols, as are for example commercially obtainable under the names Corona®, White Swan®, Coronet® or Fluilan®, may of course also be used according to the invention. The fatty alcohols are used in quantities of 0.1-30 wt. %, relative to the total preparation, preferably in quantities of 0.1-20 wt. %.

Natural or synthetic waxes (Fatwax) which may be used according to the invention are solid paraffins or isoparaffins, carnauba waxes, beeswaxes, candelilla waxes, ozokerites, ceresin, spermaceti, sunflower wax, fruit waxes such as for example apple wax or citrus wax, or PE or PP microwaxes. Such waxes are obtainable for example through Kahl & Co., Trittau.

The quantity used amounts to 0.1-50 wt. % relative to the entire agent, preferably 0.1-20 wt. % and more preferably 0.1-15 wt. % relative to the entire agent.

Natural and synthetic cosmetic oils include, for example:
plant oils, for example acai oil, seaweed oil, amaranth seed oil, anise oil, annatto oil, apricot kernel oil, appleseed oil, argan oil, avellana oil, avocado oil, babacu oil, babassu oil, baobab oil, cottonseed oil, bitter almond oil, borage seed oil, broccoli seed oil, camelina oil, cashew oil, cupuacu oil, thistle oil, peanut oil, eucalyptus oil, fennel oil, fish oil, pomegranate seed oil, grapefruit seed oil, rose hip seed oil, hemp oil, hazelnut oil, raspberry seed oil, elderberry seed oil, honeydew melon oil, jatropha oil, blackcurrant seed oil, St. John's wort oil, jojoba oil, cocoa butter, cocoa oil, coffee oil, camellia oil, cherry stone oil, coconut oil, pumpkin seed oil, salmon oil, linseed oil, linseed oil, camelina oil, bay oil, macadamia nut oil, maize germ oil, almond oil, mango butter, passion fruit oil, manila oil, melon oil, poppy seed oil, evening primrose oil, mink oil, olive oil, olive stone oil, palm oil, palm kernel oil, papaya seed oil, patchouli oil, peach stone oil, plum stone oil, pecan oil, perilla oil, pistachio oil, cranberry seed oil, rambutan oil, rapeseed oil, rice germ oil, rice oil, castor oil, sacha inchi oil, sea buckthorn fruit oil, sea buckthorn seed oil, black cumin oil, mustard oil, sesame oil, shea butter, soy oil, sunflower oil, squalane oil, sweet almond oil, tea tree oil, thyme oil, grapeseed oil, tung oil, ucuuba butter, vassoura oil, walnut oil, watermelon oil, wheat germ oil, lady's smock oil, wild rose oil, yak hair oil, ylang-ylang oil or civet oil. This list should be taken to be exemplary. Any natural oil, in particular any oil which is known as a foodstuff or from the field of naturopathy, and the liquid fractions of coconut oil. However, other triglyceride oils such as the liquid fractions of beef fat together with synthetic triglyceride oils are also suitable.
liquid paraffin oils, isoparaffin oils and synthetic hydrocarbons and di-n-alkyl ethers with a total of between 12 and 36 C atoms, in particular 12 to 24 C atoms, such as for example di-n-octyl ether, di-n-decyl ether, di-n-nonyl ether, di-n-undecyl ether, di-n-dodecyl ether, n-hexyl-n-octyl ether, n-octyl-n-decyl ether, n-decyl-n-undecyl ether, n-undecyl-n-dodecyl ether and n-hexyl-n-undecyl ether and di-tert.-butyl ether, di-iso-pentyl ether, di-3-ethyldecyl ether, tert.-butyl-n-octyl ether, iso-pentyl-n-octyl ether and 2-methylpentyl-n-octyl ether. The compounds 1,3-di-(2-ethylhexyl)cyclohexane (Cetiol®S) and di-n-octyl ether (Cetiol®OE) obtainable as commercial products may be preferred.
trifatty acid esters of saturated and/or unsaturated linear and/or branched fatty acids with glycerol, fatty acid partial glycerides, i.e. monoglycerides, diglycerides and the technical mixtures thereof. When using technical products, small quantities of triglycerides may still be present therein, depending on the production method. Partial glycerides preferably comply with formula (D4-I),

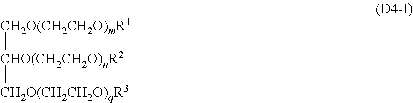

in which R¹, R² and R³ mutually independently denote hydrogen or a linear or branched, saturated and/or unsaturated acyl residue with 6 to 22, preferably 12 to 18, carbon atoms, with the proviso that at least one of these groups denotes an acyl residue and at least one of these groups denotes hydrogen. The sum (m+n+q) denotes 0 or numbers from 1 to 100, preferably 0 or 5 to 25. Preferably, R¹ denotes an acyl residue and R² and R³ denote hydrogen and the sum (m+n+q) is 0. Typical examples are mono- and/or diglycerides based on caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, elaeostearic acid, arachidic acid, gadoleic acid, behenic acid and erucic acid and the technical mixtures thereof. Preferably, oleic acid monoglycerides are used.

Ester oils which are described below: ester oils should be taken to mean the esters of C₆-C₃₀ fatty acids with C₂-C₃₀ fatty alcohols. The monoesters of fatty acids with alcohols with 2 to 24 C atoms are preferred. Examples of fatty acid moieties used in the esters are caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselinic acid, linoleic acid, linolenic acid, elaeostearic acid, arachidic acid, gadoleic acid, behenic acid and erucic acid and the technical mixtures thereof. Examples of fatty alcohol moieties in the ester oils are isopropyl alcohol, caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol and the technical mixtures thereof. More preferred substances according to the invention are isopropyl myristate (Rilanit® IPM), isononanoic acid C₁₆₋₁₈ alkyl esters (Cetiol® SN), 2-ethylhexyl palmitate (Cegesoft® 24), stearic acid 2-ethylhexyl ester (Cetiol® 868), cetyl oleate, glycerol tricaprylate, coco fatty alcohol caprate/caprylate (Cetiol® LC), n-butyl stearate, oleyl erucate (Cetiol® J 600), isopropyl palmitate (Rilanit® IPP), oleyl oleate (Cetiol®), lauric acid hexyl ester (Cetiol® A), di-n-butyl adipate (Cetiol® B), myristyl myristate (Cetiol® mm), cetearyl isononanoate (Cetiol® SN), oleic acid decyl ester (Cetiol® V).

The ester oils may, of course, also be alkoxylated with ethylene oxide, propylene oxide or mixtures of ethylene oxide and propylene oxide. Alkoxylation may here proceed not only on the fatty alcohol moiety and the fatty acid moiety but also on both moieties of the ester oils. It is, however, preferred according to the invention if the fatty alcohol was alkoxylated first and then esterified with fatty acid. Formula (D4-II) is a general representation of these compounds.

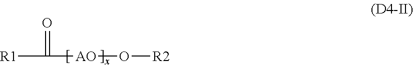

R¹ here denotes a saturated or unsaturated, branched or unbranched, cyclic saturated or cyclic unsaturated acyl residue with 6 to 30 carbon atoms, AO denotes ethylene oxide, propylene oxide or butylene oxide,
X denotes a number between 1 and 200, preferably 1 and 100, more preferably between 1 and 50, particularly preferably between 1 and 20, highly preferably between 1 and 10 and most preferably between 1 and 5,
R² denotes a saturated or unsaturated, branched or unbranched, cyclic saturated or cyclic unsaturated alkyl, alkenyl, alkynyl, phenyl or benzyl residue with 6 to 30 carbon atoms. Examples of fatty acid moieties used as residue R¹ in the esters are caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselinic acid, linoleic acid, linolenic acid, elaeostearic acid, arachidic acid, gadoleic acid, behenic acid and erucic acid and the technical mixtures thereof. Examples of fatty alcohol moieties as residue R² in the ester oils are benzyl alcohol, isopropyl alcohol, caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol and the technical mixtures thereof. One ester oil which is more preferred according to the invention is for example obtainable under the INCI name PPG-3 Benzyl Ether Myristate.

Ester oils should furthermore be taken to be:
dicarboxylic acid esters such as di-n-butyl adipate, di-(2-ethylhexyl) adipate, di-(2-ethylhexyl) succinate and diisotridecyl acelate and diol esters such as ethylene glycol dioleate, ethylene glycol diisotridecanoate, propylene glycol di(2-ethylhexanoate), propylene glycol diisostearate, propylene glycol dipelargonate, butanediol diisostearate, neopentyl glycol dicaprylate, and
symmetrical, asymmetrical or cyclic esters of carbonic acid with fatty alcohols, for example glycerol carbonate or dicaprylyl carbonate (Cetiol® CC),
trifatty acid esters of saturated and/or unsaturated linear and/or branched fatty acids with glycerol,
fatty acid partial glycerides, i.e. monoglycerides, diglycerides and the technical mixtures thereof. Typical examples are mono- and/or diglycerides based on caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, elaeostearic acid, arachidic acid, gadoleic acid, behenic acid and erucic acid and the technical mixtures thereof. Preferably, oleic acid monoglycerides are used.

The natural and synthetic oils are used in the compositions according to the invention in a quantity of 0.01 to 20 wt. %, preferably 0.01 to 10.0 wt. %, more preferably 0.01 to 7.5 wt. %, highly preferably of 0.1 to 5.0 wt. %. It is, of course, also possible according to the invention to use a plurality of ester oils simultaneously.

A further more preferred ingredient in the present invention may be a silicone polymer. At least one silicone polymer selected from the group of dimethiconols and/or the group of amino-functional silicones and/or the group of dimethicones and/or the group of cyclomethicones is preferably present in the soap composition according to the invention. These silicone polymers are described below.

The dimethicones according to the invention may be both linear and branched and cyclic or cyclic and branched. Linear dimethicones may be represented by the following structural formula (Si1):

(SiR¹₃)—O—(SiR²₂—O—)ₓ—(SiR¹₃) (Si1)

Branched dimethicones may be represented by the structural formula (Si1.1):

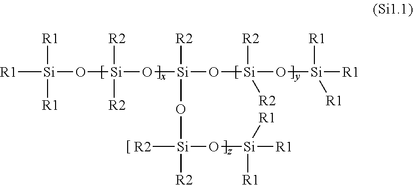

The residues R¹ and R² mutually independently in each case denote hydrogen, a methyl residue, a C₂ to C₃₀ linear, saturated or unsaturated hydrocarbon residue, a phenyl residue and/or an aryl residue. The numbers x, y and z are integers and in each case mutually independently range from 0 to 50,000. The molar weights of the dimethicones are between 1000 D and 10000000 D. Viscosities are between 100 and 10000000 cPs measured at 25° C. with the assistance of a glass capillary viscometer using the Dow Corning Corporate Test Method CTM 0004 of 20 Jul. 1970. Preferred viscosities are between 1000 and 5000000 cPs, particularly preferred viscosities are between 10000 and 3000000 cPs. The most preferred range is between 50000 and 2000000 cPs. Viscosities around the range of approximately 60,000 cPs are highly preferred. Reference may be made by way of example to the product “Dow Corning 200, 60000 cSt”.

More preferred cosmetic or dermatological preparations according to the invention are characterized in that they include at least one silicone of formula (Si-1.2)

(CH₃)₃Si—[—O—Si(CH₃)₂]ₓ—O—Si(CH₃)₃ (Si1.2),

in which x denotes a number from 0 to 100, preferably from 0 to 50, more preferably from 0 to 20 and in particular from 0 to 10.

The dimethicones (Si1) are present in the compositions according to the invention in quantities of 0.01 to 10 wt. %, preferably 0.01 to 8 wt. %, more preferably 0.1 to 7.5 wt. % and in particular 0.1 to 5 wt. % relative to the entire composition.

Finally, silicone compounds are taken to mean dimethiconols (Si8). The dimethiconols according to the invention may be both linear and branched and cyclic or cyclic and branched. Linear dimethiconols may be represented by the following structural formula (Si8-I):

(SiOHR¹₂)—O—(SiR²₂—O—)ₓ—(SiOHR¹₂) (Si8-I)

Branched dimethiconols may be represented by the structural formula (Si8-II):

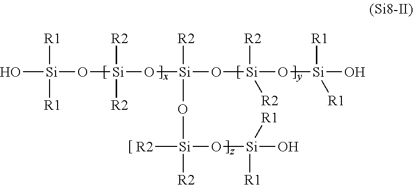

The residues R¹ and R² mutually independently denote in each case hydrogen, a methyl residue, a C₂ to C₃₀ linear, saturated or unsaturated hydrocarbon residue, a phenyl residue and/or an aryl residue. The numbers x, y and z are integers and in each case mutually independently range from 0 to 50,000. The molar weights of the dimethiconols are between 1000 D and 10000000 D. Viscosities are between 100 and 10000000 cPs measured at 25° C. with the assistance of a glass capillary viscometer using the Dow Corning Corporate Test Method CTM 0004 of 20 Jul. 1970. Preferred viscosities are between 1000 and 5000000 cPs, particularly preferred viscosities are between 10000 and 3000000 cPs. The most preferred range is between 50000 and 2000000 cPs.

The following commercial products can be mentioned as examples of such products: Dow Corning 1-1254 Fluid, Dow Corning 2-9023 Fluid, Dow Corning 2-9026 Fluid, Abil OSW 5 (Degussa Care Specialties), Dow Corning 1401 Fluid, Dow Corning 1403 Fluid, Dow Corning 1501 Fluid, Dow Corning 1784 HVF Emulsion, Dow Corning 9546 Silicone Elastomer Blend, SM555, SM2725, SM2765, SM2785 (all above-stated from GE Silicones), Wacker-Belsil CM 1000, Wacker-Belsil CM 3092, Wacker-Belsil CM 5040, Wacker-Belsil DM 3096, Wacker-Belsil DM 3112 VP, Wacker-Belsil DM 8005 VP, Wacker-Belsil DM 60081 VP (all above-stated from Wacker-Chemie GmbH).

The dimethiconols (Si8) are in the compositions according to the invention in quantities of 0.01 to 10 wt. %, preferably 0.01 to 8 wt. %, more preferably 0.1 to 7.5 wt. % and in particular 0.1 to 5 wt. % of dimethiconol relative to the composition.

More preferred agents according to the invention include one or more amino-functional silicones. Such silicones may, for example, be described by the formula (Si-2)

M(RₐO_{b}SiO_{(4-a-b)/2})ₓ(R_{c}SiO_{(4-c)/2})_{y}M (SI-2)

wherein in the above formula
R is a hydrocarbon or a hydrocarbon residue with 1 to approximately 6 carbon atoms,
Q is a polar residue of the general formula —R¹HZ,
   in which
   R¹ is a divalent linking group which is attached to hydrogen and the residue Z and is composed of carbon and hydrogen atoms, carbon, hydrogen and oxygen atoms or carbon, hydrogen and nitrogen atoms, and
   Z is an organic, amino-functional residue which includes at least one amino-functional group;
a assumes values in the range from approximately 0 to approximately 2,
b assumes values in the range from approximately 1 to approximately 3,
a+b is less than or equal to 3, and
c is a number in the range from approximately 1 to approximately 3, and
x a number in the range from 1 to approximately 2,000, preferably from approximately 3 to approximately 50 and most preferably from approximately 3 to approximately 25, and
y is a number in the range from approximately 20 to approximately 10,000, preferably from approximately 125 to approximately 10,000 and most preferably from approximately 150 to approximately 1,000, and
M is a suitable silicone end group as known from the prior art, preferably trimethylsiloxy.

According to formula (Si-2), Z is an organic, amino-functional residue including at least one functional amino group. One possible formula for said Z is NH(CH₂)_{z}NH₂, in which z is an integer greater than or equal to 1. Another possible formula for said Z is —NH(CH₂)_{z}(CH₂)_{zz}NH, in which both z and zz are mutually independently an integer greater than or equal to 1, wherein this structure comprises diamino ring structures, such as piperazinyl. Said Z is most preferably an —NHCH₂CH₂NH₂ residue. Another possible formula for said Z is —N(CH₂)_{z}(CH₂)_{zz}NX₂ or —NX₂, in which each X of X₂ is independently selected from the group consisting of hydrogen and alkyl groups with 1 to 12 carbon atoms, and zz is 0.

Q according to formula (Si-2) is most preferably a polar amino-functional residue of formula —CH₂CH₂CH₂NHCH₂CH₂NH₂.

In formula (Si-2), a assumes values in the range from 0 to 2, b assumes values in the range from 2 to 3, a+b is less than or equal to 3, and c is a number in the range from 1 to 3. Cationic silicone oils which are suitable according to the invention are for example the commercially obtainable products Dow Corning (DC) 929 Emulsion, DC 2-2078, DC 5-7113, SM-2059 (General Electric) and SLM-55067 (Wacker).

More preferred agents according to the invention are characterized in that they include at least one amino-functional silicone of formula (Si3-a)

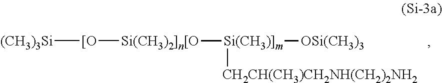

in which m and n are numbers, the sum (m+n) of which amounts to between 1 and 2000, preferably between 50 and 150, wherein n preferably assumes values from 0 to 1999 and in particular from 49 to 149 and m preferably assumes values from 1 to 2000, in particular from 1 to 10.

According to the INCI declaration, these silicones are designated trimethylsilylamodimethicones and are obtainable for example under the name Q2-7224 (manufacturer: Dow Corning; a stabilized trimethylsilylamodimethicone).

Agents according to the invention which are more preferred are also those which include at least one amino-functional silicone of formula (Si-3b)

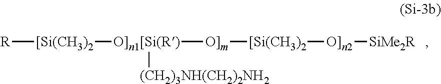

in which
R denotes —OH, an (optionally ethoxylated and/or propoxylated) (C₁ to C₂₀) alkoxy group or a —CH₃ group,
R′ denotes —OH, a (C₁ to C₂₀) alkoxy group or a —CH₃ group and
m, n1 and n2 are numbers, the sum (m+n1+n2) of which amounts to between 1 and 2000, preferably between 50 and 150, wherein the sum of (n1+n2) preferably assumes values from 0 to 1999 and in particular from 49 to 149 and m preferably assumes values from 1 to 2000, in particular from 1 to 10.

According to the INCI declaration, these silicones are designated amodimethicones or functionalized amodimethicones, such as for example Bis(C13-15 Alkoxy) PG Amodimethicone (for example obtainable as the commercial product DC 8500 from Dow Corning), Trideceth-9 PG-Amodimethicone (for example obtainable as the commercial product Silcare Silicone SEA from Clariant).

Suitable diquaternary silicones are selected from compounds of the general formula (Si3c)

[R¹R²R³N⁺-A-SiR⁷R⁸—(O—SiR⁹R¹O)ₙ—O—SiR¹¹R¹²-A-N⁺R⁴R⁵R⁶]2X⁻ (Si3c)

wherein the residues R¹ to R⁶ mutually independently mean C₁ to C₂₂ alkyl residues which may include hydroxyl groups and wherein preferably at least one of the residues has at least 8 C atoms and the remaining residues have 1 to 4 C atoms, residues R⁷ to R¹² are mutually independently identical or different and mean C₁ to C₁₀ alkyl or phenyl,
A means a divalent organic linking group,
n is a number from 0 to 200, preferably from 10 to 120, more preferably from 10 to 40, and X⁻ is an anion.

The divalent linking group is preferably a C₁ to C₁₂ alkylene or alkoxyalkylene group which may be substituted with one or more hydroxyl groups. The group —(CH₂)₃—O—CH₂—CH(OH)—CH₂— is more preferred.

The anion X⁻ may be a halide ion, an acetate, an organic carboxylate or a compound of general formula RSO3⁻, in which R has the meaning of C₁ to C₄ alkyl residues.

A preferred diquaternary silicone has the general formula (Si3d)

[RN⁺Me₂-A-(SiMe₂O)ₙ—SiMe₂-A-N⁺Me₂R]₂CH₃COO⁻ (Si3d),

wherein A is the group —(CH₂)₃—O—CH₂—CH(OH)—CH₂—,
R is an alkyl residue with at least 8 C atoms and n a number from 10 to 120.

Suitable silicone polymers with two terminal, quaternary ammonium groups are known by the INCI name Quaternium-80. These are dimethylsiloxanes with two terminal trialkylammonium groups. Such diquaternary polydimethylsiloxanes are distributed by Evonik under the trade names Abil® Quat 3270, 3272 and 3474.

Agents which are preferred according to the invention are characterized in that, relative to the weight thereof, they include 0.01 to 10 wt. %, preferably 0.01 to 8 wt. %, more preferably 0.1 to 7.5 wt. % and in particular 0.2 to 5 wt. % of amino-functional silicone(s) and/or diquaternary silicone.

Polyammonium-polysiloxane compounds are further silicones according to the invention with amino functions. The polyammonium-polysiloxane compounds may for example be obtained from GE Bayer Silicones under the trade name Baysilone®. The products named Baysilone TP 3911, SME 253 and SFE 839 are here preferred. It is particularly preferred to use Baysilone TP 3911 as an active component of the compositions according to the invention. The polyammonium-polysiloxane compounds are used in the compositions according to the invention in a quantity of 0.01 to 10 wt. %, preferably 0.01 to 7.5, more preferably 0.01 to 5.0 wt. %, particularly preferably of 0.05 to 2.5 wt. % in each case relative to the total composition.

EP 1887024 A1 describes novel cationic amino-functional silicones which in particular improve gloss in agents for conditioning surfaces, for example human hair. These cationic silicone polymers are distinguished in that they have a silicone backbone and at least one polyether moiety and furthermore at least one moiety with an ammonium structure. Examples of preferred cationic silicone polymers for the purposes of the present invention are, in addition to the compounds of the above-stated EP 1887024 A1, furthermore in particular the compounds with the INCI names: Silicone Quaternium-1, Silicone Quaternium-2, Silicone Quaternium-3, Silicone Quaternium-4, Silicone Quaternium-5, Silicone Quaternium-6, Silicone Quaternium-7, Silicone Quaternium-8, Silicone Quaternium-9, Silicone Quaternium-10, Silicone Quaternium-11, Silicone Quaternium-12, Silicone Quaternium-15, Silicone Quaternium-16, Silicone Quaternium-17, Silicone Quaternium-18, Silicone Quaternium-20, Silicone Quaternium-21, Silicone Quaternium-22 and Silicone Quaternium-2 Panthenol Succinate and Silicone Quaternium-16/Glycidol Dimethicone Crosspolymer. Silicone Quaternium-22 is in particular most preferred. This raw material is distributed for example by Evonik under the trade name Abil® T-Quat 60.

The cationic aminofunctional silicone polymers are present in the compositions according to the invention in quantities of 0.01 to 20 wt. %, preferably in quantities of 0.05 to 10 wt. % and particularly preferably in quantities of 0.1 to 7.5 wt. %. The very best results are obtained with quantities of 0.1 to 5 wt. % in each case relative to the total composition of the respective agent.

Trimethylsiloxysilicate is a further silicone according to the invention. Trimethylsiloxysilicate is a co-hydrolysis product of tetraalkoxysilane and trimethylethoxysilane. This product forms a three-dimensional network of polysilicic acid units which are terminated with trimethylsilyl groups, wherein under certain circumstances it includes a small proportion of ethoxy and hydroxy functions. The average molecular weight of the trimethylethoxysilane may be determined from the ratio of tetraalkoxysilane units to trimethylethoxysilane units. This ratio preferably amounts to 0.5 to 1.0, more preferably 0.66. One example of a trimethylethoxysilane with a ratio of 0.66 is Wacker-Belsil TMS 803 from Wacker-Chemie GmbH, Munich.

An exemplary formula for trimethylsiloxysilicate is

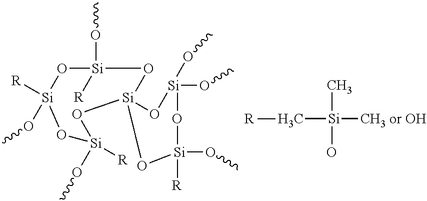

Trimethylsiloxysilicate is a water-resistant additive which can be used as a film former and fixative.

Agents which are preferred according to the invention include trimethylsiloxysilicate within relatively narrow quantity ranges. Soap bars which are preferred according to the invention are characterized in that, relative to the weight thereof, they include 0.001 to 4 wt. %, preferably 0.01 to 3.5 wt. %, further preferably 0.1 to 3 wt. %, still more preferably 0.1 to 2.5 wt. %, more preferably 0.1 to 2 wt. % and in particular 0.2 to 1 wt. % of trimethylsiloxysilicate.

In addition to the trimethylsiloxysilicates, the active substance complex of the soap bars according to the invention may include polyalkylsilsesquioxane.

Polyalkylsilsesquioxanes are compounds from the group of polyhedral oligomeric silsesquioxanes (POSS) which are described by the empirical formula RSiO_{1.5}, wherein R is an organic substituent, such as for example hydrogen, siloxy or cyclic or linear aliphatic or aromatic group, which may additionally include reactive functional groups, for example alcohol, ester, amine, keto, olefin, ether or halide groups. The basic structure of POSS compounds has a polyhedral Si—O backbone onto which the R groups are attached. Homoleptic POSS compounds including just one kind of R groups and heteroleptic POSS chemicals including in each case different R groups are known.

Polyalkylsilsesquioxanes, i.e. the residues R are alkyl residues, are used according to the invention. Homoleptic polyalkylsilsesquioxanes, i.e. each molecule includes only one kind of alkyl residue, are more preferably used according to the invention.

The following polyalkylsilsesquioxanes may, for example, be used according to the invention: isooctyl-POSS [Me₃CCH₂CH(Me)CH₂]ₙTₙ, wherein n=8, 10 or 12, octacyclohexyl-POSS C₄₈H₈₈O₁₂Si₈, octacyclopentyl-POSS C₄₀H₇₂O₁₂Si₈, octaisobutyl-POSS C₃₂H₇₂O₁₂Si₈, octamethyl-POSS C₈H₂₄O₁₂Si₈.

It is particularly preferred to use polypropylsilsesquioxane, i.e. the residue R in formula RSiO_{1.5} is a propyl residue, wherein “propyl residue” is taken to mean both n-propyl and isopropyl residues Soap bars which are particularly preferred according to the invention are characterized in that, relative to the weight thereof, they include 0.001 to 4 wt. %, preferably 0.01 to 3.5 wt. %, further preferably 0.1 to 3 wt. %, still more preferably 0.1 to 2.5 wt. %, more preferably 0.1 to 2 wt. % and in particular 0.2 to 1 wt. % of polypropylsilsesquioxane.

The cyclic dimethicones designated according to INCI as cyclomethicones may preferably be used according to the invention. Cosmetic or dermatological preparations which are preferred according to the invention are those which include at least one silicone of formula (Si-4)

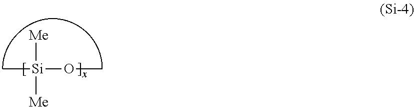

in which x denotes a number from 3 to 200, preferably from 3 to 10, more preferably from 3 to 7 and in particular 3, 4, 5 or 6.

Agents which are likewise preferred according to the invention are those which are characterized in that they include at least one silicone of formula (Si-5)

R³Si—[SiR²]ₓ—(CH₂)ₙ[—O—SiR²]_{y}—O—SiR³ (Si-5),

in which R denotes identical or different residues from the group —H, -phenyl, -benzyl, —CH₂—CH(CH₃)Ph, C₁₋₂₀ alkyl residues, preferably —CH₃, —CH₂CH₃, —CH₂CH₂CH₃, —CH(CH₃)₂, —CH₂CH₂CH₂H₃, —CH₂CH(CH₃)₂, —CH(CH₃)CH₂CH₃, —C(CH₃)₃, x and/or y denote a number from 0 to 200, preferably from 0 to 10, further preferably from 0 to 7 and in particular 0, 1, 2, 3, 4, 5 or 6, and n denotes a number from 0 to 10, preferably from 1 to 8 and in particular 2, 3, 4, 5 or 6.

Further silicones which may be present in the compositions according to the invention, in addition to the dimethicones, dimethiconols, amodimethicones and/or cyclomethicones according to the invention, are water-soluble silicones.

Corresponding hydrophilic silicones are selected, for example, from the compounds of formulae (Si-6) and/or (Si-7). Particularly preferred water-soluble silicone-based surfactants are selected from the group of dimethicone copolyols which are preferably alkoxylated, in particular polyethoxylated or polypropoxylated.

According to the invention, dimethicone copolyols are preferably taken to mean polyoxyalkylene-modified dimethylpolysiloxanes of the general formulae (Si-6) or (Si-7):

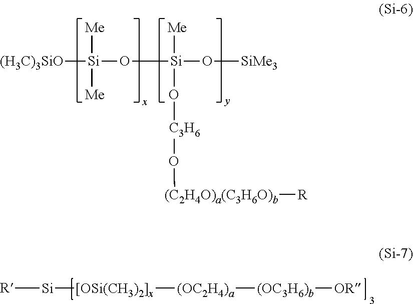

in which the residue R denotes a hydrogen atom, an alkyl group with 1 to 12 C atoms, an alkoxy group with 1 to 12 C atoms or a hydroxyl group, the residues R′ and R″ mean alkyl groups with 1 to 12 C atoms, x denotes an integer from 1 to 100, preferably from 20 to 30, y denotes an integer from 1 to 20, preferably from 2 to 10 and a and b denote integers from 0 to 50, preferably from 10 to 30.

Dimethicone copolyols which are more preferred for the purposes of the invention are for example the products commercially distributed under the trade name SILWET (Union Carbide Corporation) and DOW CORNING. Dimethicone copolyols which are more preferred according to the invention are Dow Corning 190 and Dow Corning 193.

The dimethicone copolyols are in the compositions according to the invention in quantities of 0.01 to 10 wt. %, preferably 0.01 to 8 wt. %, more preferably 0.1 to 7.5 wt. % and in particular 0.1 to 5 wt. % of dimethicone copolyol relative to the composition.

Polymers may advantageously also be used in the soap bars according to the invention. The cationic and/or amphoteric polymers may be homo- or copolymers or polymers based on natural polymers, wherein the quaternary nitrogen groups are present either in the polymer chain or preferably as substituents on one or more of the monomers. Monomers including ammonium groups may be copolymerized with non-cationic monomers. Suitable cationic monomers are unsaturated, free-radically polymerizable compounds which bear at least one cationic group, in particular ammonium-substituted vinyl monomers such as for example trialkylmethacryloxyalkylammonium, trialkylacryloxyalkylammonium, dialkyldiallylammonium and quaternary vinylammonium monomers with cyclic, cationic nitrogen-including groups such as pyridinium, imidazolinium or quaternary pyrrolidones, for example alkylvinylimidazolium, alkylvinylpyridinium, or alkylvinylpyrrolidone salts. The alkyl groups of these monomers are preferably lower alkyl groups such as for example C₁ to C₇ alkyl groups, more preferably C₁ to C₃ alkyl groups.

Monomers including ammonium groups may be copolymerized with non-cationic monomers. Suitable comonomers are for example acrylamide, methacrylamide; alkyl- and dialkylacrylamide, alkyl- and dialkylmethacrylamide, alkyl acrylate, alkyl methacrylate, vinylcaprolactone, vinylcaprolactam, vinylpyrrolidone, vinyl esters, for example vinyl acetate, vinyl alcohol, propylene glycol or ethylene glycol, wherein the alkyl groups of these monomers are preferably C₁ to C₇ alkyl groups, more preferably C₁ to C₃ alkyl groups.

Among the numerous polymers of this kind, the following have proven to be particularly effective components of the active substance complex according to the invention:

homopolymers of the general formula —{CH₂—[CR¹COO—(CH₂)ₘN⁺R²R³R⁴]}ₙX⁻,
in which R¹=—H or —CH₃, R², R³ and R⁴ are mutually independently selected from C₁₋₄ alkyl, alkenyl or hydroxyalkyl groups, m=1, 2, 3 or 4, n is a natural number and X⁻ is a physiologically acceptable organic or inorganic anion. In the context of these polymers, those which are preferred according to the invention are those for which at least one of the following conditions applies: R¹ denotes a methyl group, R², R³ and R⁴ denote methyl groups, m has the value 2.

Physiologically acceptable counterions X⁻ which may, for example, be considered are halide ions, sulfate ions, phosphate ions, methosulfate ions and organic ions such as lactate, citrate, tartrate and acetate ions. Methosulfate and halide ions, in particular chloride, are preferred.

Further preferred cationic polymers are for example copolymers of formula (I). The soap bars according to the invention preferably contain, relative to the weight thereof, 0.001 to 5 wt. %, preferably 0.0025 to 2.5 wt. %, more preferably 0.005 to 1 wt. %, further preferably 0.0075 to 0.75 wt. % and in particular 0.01 to 0.5 wt. % of at least one copolymer A of the general formula (I),

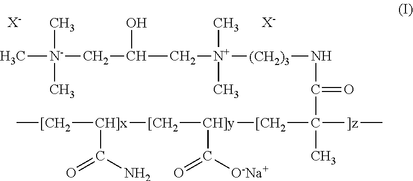

in which:

x+y+z=Q
Q denotes values from 3 to 55000, preferably from 10 to 25000, more preferably from 50 to 15000, further preferably from 100 to 10000, still more preferably from 500 to 8000 and in particular from 1000 to 5000,
   x denotes (0 to 0.5) Q, preferably (0 to 0.3) Q and in particular the values 0, 1, 2, 3, 4, 5, wherein the value 0 is preferred,
Y denotes (0.1 to 0.95) Q, preferably (0.5 to 0.7) Q and in particular values from 1 to 24000, preferably from 5 to 15000, more preferably from 10 to 10000 and in particular from 100 to 4800,
z denotes (0.001 to 0.5) Q, preferably (0.1 to 0.5) Q and in particular values from 1 to 12500, preferably from 2 to 8000, more preferably from 3 to 4000 and in particular from 5 to 2000.

According to the invention, preferred copolymers A of formula (I) are characterized in that the ratio (y:z) amounts to 4:1 to 1:2, preferably 4:1 to 1:1 and the molar mass is 10000 to 20 million gmol⁻¹, preferably 100000 to 10 million gmol⁻¹, further preferably 500000 to 5 million gmol⁻¹ and in particular from 1.1 million to 2.2 million gmol⁻¹. One highly preferred polymer which is of the above-described structure is commercially obtainable under the name Polyquaternium-74.

One particularly suitable homopolymer is poly(methacryloyloxyethyltrimethylammonium chloride), which may if desired be crosslinked, with the INCI name Polyquaternium-37. Such products are commercially obtainable for example under the names Rheocare® CTH (Cosmetic Rheologies) and Synthalen® CR (3V Sigma).

The homopolymer is preferably used in the form of a nonaqueous polymer dispersion. Such polymer dispersions are commercially obtainable under the names Salcare® SC 95 and Salcare® SC 96.

Suitable cationic polymers which are derived from natural polymers are cationic derivatives of polysaccharides, for example cationic derivatives of cellulose, starch or guar. Chitosan and chitosan derivatives are furthermore suitable. Cationic polysaccharides have the general formula

G-O—B—N⁺RₐR_{b}R_{c}A⁻

G is an anhydroglucose residue, for example starch or cellulose anhydroglucose;
B is a divalent linking group, for example alkylene, oxyalkylene, polyoxyalkylene or hydroxyalkylene;
Rₐ, R_{b} and R_{c} are mutually independently alkyl, aryl, alkylaryl, arylalkyl, alkoxyalkyl or alkoxyaryl in each case with up to 18 C atoms, wherein the total number of C atoms in Rₐ, R_{b} and R_{c} preferably amounts to at most 20;
X⁻ is a conventional counteranion and is preferably chloride.

Cationic, thus quaternized, celluloses are commercially obtainable with different degrees of substitution, cationic charge densities, nitrogen contents and molecular weights. For example, Polyquaternium-67 is commercially offered for sale under the names Polymer® SL or Polymer® SK (Amerchol). A further highly preferred cellulose is offered for sale under the trade name Mirustyle® CP from Croda. This is a trimonium and cocodimonium hydroxyethylcellulose as a derivatized cellulose with the INCI name Polyquaternium-72. Polyquaternium-72 may be used both in solid form and already predissolved in aqueous solution.

Further cationic celluloses are known by the names Polymer JR® 400 (Amerchol, INCI name Polyquaternium-10) and Polymer Quatrisoft® LM-200 (Amerchol, INCI name Polyquaternium-24). Further commercial products are the compounds Celquat® H 100 and Celquat® L 200. Finally a further derivatized cellulose with the INCI name Polyquaternium-72 is obtainable from Croda under the trade name Mirustyle® CP with Trimonium and Cocodimonium Hydroxyethylcellulose. Polyquaternium-72 may be used both in solid form and already predissolved in aqueous solution. More preferred cationic celluloses are Polyquaternium-10, Polyquaternium-24, Polyquaternium-67 and Polyquaternium-72.

Suitable cationic guar derivatives are distributed under the trade name Jaguar® and have the INCI name Guar Hydroxypropyltrimonium Chloride. Particularly suitable cationic guar derivatives are furthermore also commercially obtainable from Hercules under the name N-Hance®. Further cationic guar derivatives are distributed by Cognis under the name Cosmedia®. One preferred cationic guar derivative is the commercial product AquaCat® from Hercules. This raw material is an already predissolved cationic guar derivative. Cationic guar derivatives are preferred according to the invention.

One suitable chitosan is for example distributed by Kyowa Oil & Fat, Japan, under the tradename Flonac®. One preferred chitosan salt is chitosoniumpyrrolidone carboxylate, which is for example distributed by Amerchol, USA, under the name Kytamer® PC. Further chitosan derivatives are readily commercially obtainable under the trade names Hydagen® CMF, Hydagen® HCMF and Chitolam® NB/101.

Further preferred cationic polymers are for example
cationic alkyl polyglycosides,
cationized honey, for example the commercial product Honeyquat® 50,
polymeric dimethyldiallylammonium salts and the copolymers thereof with esters and amides of acrylic acid and methacrylic acid. The products commercially obtainable under the names Merquat®100 (poly(dimethyldiallylammonium chloride)) and Merquat®550 (dimethyldiallylammonium chloride-acrylamide copolymer) are examples of such cationic polymers with the INCI name Polyquaternium-7,
vinylpyrrolidone-vinylimidazolium methochloride copolymers, as are offered for sale under the names Luviquat® FC 370 and FC 550 and the INCI name Polyquaternium-16 together with FC 905 and HM552,
quaternized vinylpyrrolidone/dimethylaminoethyl methacrylate, for example vinylpyrrolidone/dimethylaminoethylmethacrylate methosulfate copolymer, which is distributed by Gaf Co., USA under the trade names Gafquat® 755 N and Gafquat® 734 and the INCI name Polyquaternium-11, quaternized polyvinyl alcohol,
and the polymers known by the names Polyquaternium-2, Polyquaternium-17,

Polyquaternium-18 and Polyquaternium-27 with quaternary nitrogen atoms in the polymer main chain,
vinylpyrrolidone-vinylcaprolactam-acrylate terpolymers, as are for example offered for sale with acrylic acid esters and acrylamides as the third monomeric building block under the name Aquaflex® SF 40.

Amphoteric polymers according to the invention are those polymers in which a cationic group is derived from at least one of the following monomers:
(i) monomers with quaternary ammonium groups of the general formula (Monol),

R¹—CH═CR²—CO—Z—(CₙH₂ₙ)—N(+)R²R³R⁴A⁽⁻⁾ (Mono1)
in which R¹ and R² mutually independently denote hydrogen or a methyl group and R³, R⁴ and R⁵ mutually independently denote alkyl groups with 1 to 4 carbon atoms, Z is an NH group or an oxygen atom, n is an integer from 2 to 5 and A⁽⁻⁾ is the anion of an organic or inorganic acid,
(i) monomers with quaternary ammonium groups of the general formula (Mono2),

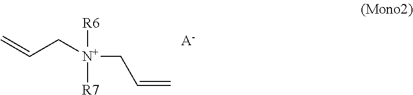

in which R⁶ and R⁷ mutually independently denote a (C₁ to C₄) alkyl group, in particular a methyl group and A⁻ is the anion of an organic or inorganic acid,
(iii) monomeric carboxylic acids of general formula (Mono3),

R⁸—CH═CR⁹—COOH (Mono3)
in which R⁸ and R⁹ are mutually independently hydrogen or methyl groups.

More preferred polymers are those in which monomers of type (i) are used, in which R³, R⁴ and R⁵ are methyl groups, Z is an NH group and A⁽⁻⁾ a halide, methoxysulfate or ethoxysulfate ion; acrylamidopropyltrimethylammonium chloride is a more preferred monomer (i). Acrylic acid is preferably used as monomer (ii) for the stated polymers.

More preferred amphoteric polymers are copolymers prepared from at least one monomer (Mono 1) or (Mono2) with the monomer (Mono3), in particular copolymers prepared from monomers (Mono2) and (Mono3). Amphoteric polymers which are particularly preferably used according to the invention are copolymers of diallyldimethylammonium chloride and acrylic acid. These copolymers are distributed under the INCI name Polyquaternium-22, inter alia with the trade name Merquat® 280 (Nalco).

Apart from a monomer (Monol) or (Mono2) and a monomer (Mono3), amphoteric polymers according to the invention may furthermore additionally include a monomer (Mono4)
(iv) monomeric carboxamides of the general formula (Mono4),

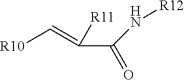

in which R¹⁰ and R¹¹ are mutually independently hydrogen or methyl groups and R¹² denotes a hydrogen atom or a (C₁ to C₈) alkyl group.

Amphoteric polymers based on a comonomer (Mono4) which are particularly preferably used according to the invention are terpolymers of diallyldimethylammonium chloride, acrylamide and acrylic acid. These copolymers are distributed under the INCI name Polyquaternium-39, inter alia with the trade name Merquat® Plus 3330 (Nalco).

The amphoteric polymers may generally be used according to the invention both directly and in salt form, which is obtained by neutralization of the polymers, for example with an alkali metal hydroxide.

The above-stated cationic polymers may be used individually or in any desired combinations with one another, wherein quantities of between 0.01 and 10 wt. %, preferably quantities of 0.01 to 7.5 wt. % and particularly preferably quantities of 0.1 to 5.0 wt. % are present. The very best results are here obtained with quantities of 0.1 to 3.0 wt. % in each case relative to the total composition of the respective agent. It may occasionally be necessary to use anionic polymers. Examples of anionic monomers of which such polymers may consist are acrylic acid, methacrylic acid, crotonic acid, maleic anhydride and 2-acrylamido-2-methylpropanesulfonic acid. In this case, the acidic groups may be present wholly or in part as a sodium, potassium, ammonium, mono- or triethanolammonium salt. 2-Acrylamido-2-methylpropanesulfonic acid and acrylic acid are preferred monomers.

Anionic polymers which have proven very particularly effective are those which include as sole or co-monomer 2-acrylamido-2-methylpropanesulfonic acid, wherein the sulfonic acid group may be present wholly or in part as a sodium, potassium, ammonium, mono- or triethanolammonium salt.

The homopolymer of 2-acrylamido-2-methylpropanesulfonic acid is more preferred, and is commercially obtainable for example under the name Rheothik®11-80.

Preferred nonionogenic monomers are acrylamide, methacrylamide, acrylic acid esters, methacrylic acid esters, vinylpyrrolidone, vinyl ethers and vinyl esters.

Preferred anionic copolymers are acrylic acid-acrylamide copolymers and in particular polyacrylamide copolymers with monomers including sulfonic acid groups. Such a polymer is present in the commercial product Sepigel®305 from SEPPIC.

Anionic homopolymers which are likewise preferred are uncrosslinked and crosslinked polyacrylic acids. In this case, allyl ethers of pentaerythritol, of sucrose and of propylene may be preferred crosslinking agents. Such compounds are commercially obtainable for example under the trademark Carbopol®. Examples are Carbopol® 934, Carbopol® 940, Carbopol® ETD 2020, Carbopol® Ultrez, Carbopol® 941 or Carbopol® 981.

Finally, carboxymethylcellulose may preferentially be used in the compositions according to the invention.

Copolymers of maleic anhydride and methyl vinyl ether, in particular those comprising crosslinks, may likewise be used. A maleic acid-methyl vinyl ether copolymer crosslinked with 1,9-decadiene is commercially obtainable under the name Stabileze® QM.

The anionic polymers are present in the agents according to the invention preferably in quantities of from 0.05 to 10 wt. %, relative to the total agent. Quantities of 0.1 to 5 wt. % are more preferred.

In a further embodiment, the agents according to the invention may include nonionogenic polymers.

Suitable nonionogenic polymers are for example:
vinylpyrrolidone/vinyl ester copolymers, as are distributed for example under the tradename Luviskol® (BASF). Luviskol® VA 64 and Luviskol® VA 73, in each case vinylpyrrolidone/vinyl acetate copolymers, are likewise preferred nonionic polymers.
cellulose ethers, such as hydroxypropylcellulose, hydroxyethylcellulose and methylhydroxypropylcellulose, as are distributed for example under the tradenames Culminal® and Benecel® (AQUALON) and Natrosol® grades (Hercules).
starch and the derivatives thereof, in particular starch ethers, for example Structure® XL (National Starch), a multifunctional, salt-tolerant starch;
shellac
polyvinylpyrrolidones, as are distributed for example under the tradename Luviskol® (BASF).

The polymers are present in the compositions according to the invention preferably in quantities of from 0.01 to 10 wt. %, relative to the total agent. Quantities of 0.1 to 5 wt. % are more preferred and quantities of 0.1 to 3 wt. % are highly preferred.

A further ingredient according to the invention in the compositions according to the invention comprises protein hydro lysates and/or the derivatives thereof.

Protein hydrolysates of both plant and animal origin or marine or synthetic origin may be used according to the invention.

Animal protein hydrolysates are for example elastin, collagen, keratin, silk and milk protein hydrolysates which may also assume salt form. Such products are distributed for example under the tradenames Dehylan® (Cognis), Promois® (Interorgana), Collapuron® (Cognis), Nutrilan® (Cognis), Gelita-Sol® (Deutsche Gelatine Fabriken Stoess & Co), Lexein® (Inolex) and Kerasol® (Croda).

Further plant protein hydro lysates which are preferred according to the invention are for example soy, almond, pea, moringa, potato and wheat protein hydrolysates. Such products are obtainable for example under the trademarks Gluadin® (Cognis), DiaMin® (Diamalt), Lexein® (Inolex), Hydrosoy® (Croda), Hydrolupin® (Croda), Hydrosesame® (Croda), Hydrotritium® (Croda), Crotein® (Croda) and Puricare® LS 9658 from Laboratoires Sérobiologigues.

Further protein hydro lysates which are preferred according to the invention are of maritime origin. These include for example collagen hydrolysates from fish or seaweed and protein hydrolysates from mussels or pearl hydrolysates. Examples of pearl extracts according to the invention are the commercial products Pearl Protein Extract BG® or Crodarom® Pearl.

Cationized protein hydrolysates should furthermore be included among protein hydrolysates and the derivatives thereof, wherein the underlying protein hydrolysate may originate from animals, for example from collagen, milk or keratin, from plants, for example from wheat, maize, rice, potato, soy or almonds, from marine life forms, for example from fish collagen or seaweed, or biotechnologically obtained protein hydrolysates. Typical examples of the cationic protein hydrolysates and derivatives according to the invention which may be mentioned are those that are commercially obtainable and mentioned under the INCI names in the “International Cosmetic Ingredient Dictionary and Handbook”, (seventh edition 1997, The Cosmetic, Toiletry, and Fragrance Association 1101 17th Street, N.W., Suite 300, Washington, D.C. 20036-4702).

The protein hydrolysates are present in the compositions in concentrations of 0.001 wt. % to 20 wt. %, preferably of 0.05 wt. % to 15 wt. % and particularly preferably in quantities of 0.05 wt. % to 5 wt. %.

A further preferred group of ingredients of the compositions according to the invention are vitamins, provitamins or vitamin precursors. Vitamins, provitamins and vitamin precursors which are more preferred are those which are assigned to groups A, B, C, E, F and H.

The group of substances designated vitamin A includes retinol (vitamin Ai) and 3,4-didehydroretinol (vitamin A2). β-Carotene is the provitamin of retinol. Examples of substances which may be considered according the invention as the vitamin A component are vitamin A acid and the esters thereof, vitamin A aldehyde and vitamin A alcohol and the esters thereof such as the palmitate and the acetate. The agents according to the invention preferably include the vitamin A component in quantities of from 0.05-1 wt. %, relative to the total preparation.

The vitamin B group or the vitamin B complex includes, inter alia:

vitamin B₁ (thiamin)
vitamin B₂ (riboflavin)
vitamin B₃. This designation is frequently used for the compounds nicotinic acid and nicotinamide (niacinamide). Nicotinamide is preferred according to the invention and is preferably present in the agents according to the invention in quantities of from 0.05 to 1 wt. %, relative to the total agent.
Vitamin B₅ (pantothenic acid, panthenol and pantolactone). In the context of this group, panthenol and/or pantolactone are preferably used. Derivatives of panthenol which may be used according to the invention are in particular the esters and ethers of panthenol and cationically derivatized panthenols. Individual representatives are for example panthenol triacetate, panthenol monoethyl ether and the monoacetate thereof and cationic panthenol derivatives. Pantothenic acid is preferably used in the present invention as a derivative in the form of the more stable calcium salts and sodium salts (Ca pantothenate, Na pantothenate).
Vitamin B6 (pyridoxine as well as pyridoxamine and pyridoxal).

The stated compounds of the vitamin B type, in particular vitamin B₃, B₅ and B₆, are preferably present in the agents according to the invention in quantities of from 0.05-10 wt. %, relative to the total agent. Quantities of 0.1-5 wt. % are more preferred.

Vitamin C (ascorbic acid). Vitamin C is preferably used in the agents according to the invention in quantities of from 0.1 to 3 wt. %, relative to the total agent. Use in the form of the palmitic acid ester, the glucosides or phosphates may be preferred. Use in combination with tocopherols may likewise be preferred.

Vitamin E (tocopherols, in particular α-tocopherol). Tocopherol and the derivatives thereof, which include in particular the esters such as the acetate, the nicotinate, the phosphate and the succinate, are preferably present in the agents according to the invention in quantities of from 0.05-1 wt. %, relative to the total agent.

Vitamin F. The term “vitamin F” is conventionally understood to mean essential fatty acids, in particular linoleic acid, linolenic acid and arachidonic acid.

Vitamin H. Vitamin H denotes the compound (3aS,4S,6aR)-2-oxohexahydrothienol[3,4-d]-imidazole-4-valeric acid, which is now, however, known by the common name biotin. Biotin is present in the agents according to the invention preferably in quantities of from 0.0001 to 1.0 wt. %, in particular in quantities of from 0.001 to 0.01 wt. %.

The agents according to the invention preferably include vitamins, provitamins and vitamin precursors from the groups A, B, E and H. Panthenol, pantolactone, pyridoxine and the derivatives thereof and nicotinamide and biotin are more preferred.

One more preferred group of ingredients in the cosmetic compositions according to the invention are the betaines stated below: carnitine, carnitine tartrate, carnitine magnesium citrate, acetylcarnitine, betalains, 1,1-dimethylproline, choline, choline chloride, choline bitartrate, choline dihydrogencitrate and the compound N,N,N-trimethylglycine which is designated as a betaine in the literature.

Carnitine, histidine, choline and betaine are preferably used. L-Carnitine tartrate is used as active substance in a more preferred embodiment of the invention.

In a further embodiment which is preferred according to the invention, the compositions according to the invention include bioquinones. In the agents according to the invention, suitable bioquinones should be taken to mean one or more ubiquinone(s) and/or plastoquinone(s). Ubiquinones which are preferred according to the invention have the following formula:

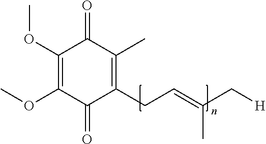

with n=6, 7, 8, 9 or 10.
Coenzyme Q-10 is here most preferred.

Preferred compositions according to the invention include purine and/or purine derivatives in relatively narrow quantity ranges. Cosmetic agents which are preferred according to the invention are here characterized in that, relative to the weight thereof, they include 0.001 to 2.5 wt. %, preferably 0.0025 to 1 wt. %, more preferably 0.005 to 0.5 wt. % and in particular 0.01 to 0.1 wt. % of purine(s) and/or purine derivative(s). Soap bars which are preferred according to the invention are characterized in that they include purine, adenine, guanine, uric acid, hypoxanthine, 6-purinethiol, 6-thioguanine, xanthine, caffeine, theobromine or theophylline. Caffeine is most preferred in preparations according to the invention.

In a further preferred embodiment of the present invention, the cosmetic agent includes ectoine ((S)-2-methyl-1,4,5,6-tetrahydro-4-pyrimidinecarboxylic acid).

Agents which are more preferred according to the invention are those which, relative to the weight thereof, include 0.00001 to 10.0 wt. %, preferably 0.0001 to 5.0 wt. % and in particular 0.001 to 3 wt. % of the active substances from the group which is formed by carnitine, coenzyme Q-10, ectoine, a vitamin of the B series, a purine and the derivatives thereof or physiologically acceptable salts.

One particularly preferred conditioning additive in the soap bars according to the invention is taurine. Taurine is exclusively taken to mean 2-aminoethanesulfonic acid while a derivative is taken to mean the explicitly stated derivatives of taurine. The derivatives of taurine are taken to mean N-monomethyltaurine, N,N-dimethyltaurine, taurine lysylate, taurine tartrate, taurine ornithate, lysyltaurine and ornithyltaurine.

More preferred agents according to the invention are those which, relative to the weight thereof, include 0.0001 to 10.0 wt. %, preferably 0.0005 to 5.0 wt. %, more preferably 0.001 to 2.0 wt. % and in particular 0.001 to 1.0 wt. % of taurine and/or a derivative of taurine. The action of the compositions according to the invention may be additionally increased by a 2-pyrrolidinone-5-carboxylic acid and the derivatives thereof (J). The sodium, potassium, calcium, magnesium or ammonium salts, in which, in addition to hydrogen, the ammonium ion bears one to three C₁ to C₄ alkyl groups, are preferred. The sodium salt is particularly preferred. The quantities used in the agents according to the invention amount to 0.05 to 10 wt. %, relative to the total agent, more preferably 0.1 to 5, and in particular 0.1 to 3 wt. %.

Thanks to the use of plant extracts as ingredients, the soap bars according to the invention may have a formulation which is particular close to nature while nevertheless being very effective in terms of their conditioning performance. It is optionally even possible to dispense with the preservatives which would otherwise be conventional. According to the invention, preference is above all given to extracts from green tea, oak bark, stinging nettle, witch hazel, hops, henna, chamomile, burdock root, horsetail, hawthorn, lime blossom, almond, aloe vera, pine needle, horse chestnut, sandalwood, juniper, coconut, mango, apricot, lime, wheat, kiwi fruit, melon, orange, grapefruit, sage, rosemary, birch, mallow, valerian, lady's smock, wild thyme, yarrow, thyme, melissa, restharrow, coltsfoot, marsh mallow, meristem, ginseng, coffee, cocoa, moringa, ginger root and ayurvedic plant extracts such as for example Aegle marmelos (bilwa), Cyperus rotundus (nagar motha), Emblica officinalis (amalaki), Morida citrifolia (ashyuka), Tinospora cordifolia (guduchi), Santalum album (chandana), Crocus sativus (kumkuma), Cinnamonum zeylanicum and Nelumbo nucifera (kamala), sweet grasses such as wheat, barley, rye, oats, spelt, maize, the various varieties of millet (proso millet, African finger millet, foxtail millet by way of example), sugar cane, ryegrass, meadow foxtail, oat grass, bentgrass, meadow fescue, moor grass, bamboo, cotton grass, fountain grasses, Andropogoneae (Imperata cylindrica also known as blady grass or cogon grass), buffalo grass, cordgrasses, dog's tooth grasses, lovegrasses, Cymbopogon (lemon grass), Oryzeae (rice), Zizania (wild rice), marram grass, steppe oat, softgrasses, quaking grasses, bluegrasses, couch grasses and Echinacea, in particular Echinacea purpurea (L.) Moench, all species of vine and pericarp of Litchi chinensis.

The plant extracts may be used according to the invention both in pure and in dilute form. Where used in dilute form, they conventionally include approx. 2-80 wt. % of active substance and, as solvent, the extracting agent or extracting agent mixture used to isolate them.

In a further embodiment, the agents according to the invention should additionally include at least one UV light protection filter. UVB filters may be oil-soluble or water-soluble.

Oil-soluble substances which may be mentioned are, for example:
3-benzylidenecamphor, for example 3-(4-methylbenzylidene)camphor;
4-aminobenzoic acid derivatives, preferably 4-(dimethylamino)benzoic acid 2-ethylhexyl ester, 4-(dimethylamino)benzoic acid 2-octyl ester and 4-(dimethylamino)benzoic acid amyl ester;
esters of cinnamic acid, preferably 4-methoxycinnamic acid 2-ethylhexyl ester, 4-methoxycinnamic acid propyl ester, 4-methoxycinnamic acid isoamyl ester, 2-cyano-3-phenylcinnamic acid 2-ethylhexyl ester (Octocrylene);
esters of salicylic acid, preferably salicylic acid 2-ethylhexyl ester, salicylic acid 4-isopropylbenzyl ester, salicylic acid homomethyl ester;
derivatives of benzophenone, preferably 2-hydroxy-4-methoxybenzophenone, 2-hydroxy-4-methoxy-4 ‘-methylbenzophenone, 2,2’-dihydroxy-4-methoxybenzophenone;
esters of benzalmalonic acid, preferably 4-methoxybenzalmalonic acid di-2-ethylhexyl ester;
triazine derivatives, such as for example 2,4,6-trianilino-(p-carbo-2′-ethyl-1′-hexyloxy)-1,3,5-triazine and
octyl triazone.
propane-1,3-diones, such as for example 1-(4-tert.-butylphenyl)-3-(4′-methoxyphenyl)propane-1,3-dione;

Water-soluble substances which may be considered are:
2-phenylbenzimidazole 5-sulfonic acid and the alkali and alkaline earth metal, ammonium, alkylammonium, alkanolammonium and glucammonium salts thereof;
sulfonic acid derivatives of benzophenones, preferably 2-hydroxy-4-methoxybenzophenone-5-sulfonic acid and the salts thereof;
sulfonic acid derivatives of 3-benzylidenecamphor, such as for example 4-(2-oxo-3-bornylidenemethyl)benzenesulfonic acid and 2-methyl-5-(2-oxo-3-bornylidene)sulfonic acid and the salts thereof.

Typical UVA filters which may be considered are in particular derivatives of benzoylmethane, such as for example 1-(4′-tert.-butylphenyl)-3-(4′-methoxyphenyl)propane-1,3-dione or 1-phenyl-3-(4′-isopropylphenyl)propane-1,3-dione. The UVA and UVB filters may, of course, also be used in mixtures. In addition to the stated soluble substances, insoluble pigments may also be considered for this purpose, in particular finely dispersed metal oxides or salts, such as for example titanium dioxide, zinc oxide, ferric oxide, aluminum oxide, cerium oxide, zirconium oxide, silicates (talcum), barium sulfate and zinc stearate. The particles should here have an average diameter of less than 100 nm, preferably between 5 and 50 nm and in particular between 15 and 30 nm. They may have a spherical shape, but such particles having a shape which is ellipsoidal or differs in another way from spherical may also be used.

The agents according to the invention may more preferentially include one or more amino acids as a further ingredient. Amino acids which are more preferably usable according to the invention originate from the group glycine, alanine, valine, leucine, isoleucine, phenylalanine, tyrosine, tryptophan, proline, aspartic acid, glutamic acid, asparagine, glutamine, serine, threonine, cysteine, methionine, lysine, arginine, histidine, β-alanine, 4-aminobutyric acid (GABA), betaine, L-cystine (L-Cyss), L-carnitine, L-citrulline, L-theanine, 3′,4′-dihydroxy-L-phenylalanine (L-dopa), 5′-hydroxy-L-tryptophan, L-homocysteine, S-methyl-L-methionine, S-allyl-L-cysteine sulfoxide (L-alliine), L-trans-4-hydroxyproline, L-5-oxoproline (L-pyroglutamic acid), L-phosphoserine, creatine, 3-methyl-L-histidine, L-ornithine, wherein both the individual amino acids and mixtures may be used.

Preferred agents according to the invention include one or more amino acids in relatively narrow quantity ranges. Agents which are preferred according to the invention are here characterized in that, relative to the weight thereof, they include as conditioning substance 0.01 to 5 wt. %, preferably 0.02 to 2.5 wt. %, more preferably 0.05 to 1.5 wt. %, further preferably 0.075 to 1 wt. % and in particular 0.1 to 0.25 wt. % of amino acid(s), preferably from the group glycine and/or alanine and/or valine and/or lysine and/or leucine and/or threonine.

The agents according to the invention may include at least one carbohydrate from the group of monosaccharides, disaccharides and/or oligosaccharides as a further component. Agents which are preferred according to the invention are here characterized in that, relative to the weight thereof, they include as conditioning substance 0.01 to 5 wt. %, preferably 0.05 to 4.5 wt. %, more preferably 0.1 to 4 wt. %, further preferably 0.5 to 3.5 wt. % and in particular 0.75 to 2.5 wt. % of carbohydrate(s), selected from monosaccharides, disaccharides and/or oligosaccharides, wherein preferred carbohydrates are selected from
monosaccharides, in particular
   D-ribose and/or
   D-xylose and/or
   L-arabinose and/or
   D-glucose and/or
   D-mannose and/or
   D-galactose and/or
   D-fructose and/or
   sorbose and/or
   L-fucose and/or
   L-rhamnose
disaccharides, in particular
   sucrose and/or
   maltose and/or
   lactose and/or
   trehalose and/or
   cellobiose and/or
   gentiobiose and/or
   isomaltose.

Further very particularly preferred ingredients of the agents according to the invention are polyhydroxy compounds. In a more preferred embodiment, at least one polyhydroxy compound with at least 20H groups is therefore present. Of these compounds, those having 2 to 120H groups and in particular those with 2, 3, 4, 5, 6 or 10 OH groups are preferred.

Polyhydroxy compounds with 20H groups are for example glycol (CH₂(OH)CH₂OH) and other 1,2-diols such as H—(CH₂)ₙ—CH(OH)CH₂OH with n=1, 2, 3, 4, 5, 6, 7, 8, 9, 10, 11, 12, 13, 14, 15, 16, 17, 18, 19, 20. 1,3-Diols such as H—(CH₂)ₙ—CH(OH)CH₂CH₂OH with n=1, 2, 3, 4, 5, 6, 7, 8, 9, 10, 11, 12, 13, 14, 15, 16, 17, 18, 19, 20 are also usable according to the invention. (m,n+1)- or (m,n+2)-diols with non-terminal OH groups may likewise be used.

Important representatives of polyhydroxy compounds with 2 OH groups are also polyethylene and polypropylene glycols.

Among polyhydroxy compounds with 3 OH groups, glycerol is of great significance.

Agents according to the invention in which the polyhydroxy compound is selected from ethylene glycol, propylene glycol, polyethylene glycol, polypropylene glycol and glycerol and the mixtures thereof may be preferred.

Irrespective of the type of polyhydroxy compound with at least 2 OH groups which is used, wherein glycerol is explicitly excluded at this point in the present invention, preferred agents according to the invention are those which, relative to the weight of the soap bar, include 0.01 to 20 wt. %, preferably 0.01 to 10 wt. %, more preferably 0.05 to 7.5 wt. % and in particular 0.1 to 5.0 wt. % of polyhydroxy compound(s).

One highly preferred polyhydroxy compound is glycerol. In particular in the case of soaps, glycerol arises as early as during the saponification process. The glycerol is conventionally washed out after saponification in order to keep the quantities of glycerol in the finished soap to quantities of less than 3.0 wt. %. In the present invention, saponification is controlled such that the resultant glycerol need not subsequently be washed out. Instead, the glycerol which arises remains in the raw soap. The content of glycerol in the compositions according to the invention therefore amounts to at least 3.0 wt. % to 10.0 wt. %, preferably 3.0 to 8.5 wt. %, more preferably 3.0 to 7.5 wt. % and highly preferably 3.5 to 7.0 wt. % relative to the weight of the soap bars.

However, during saponification it is not only glycerol which arises during the process, but also salts such as sodium chloride due to saponification with sodium hydroxide and subsequent neutralization for example with hydrochloric acid. Potassium chloride or ammonium salts arise correspondingly. The salt content, in particular sodium chloride content, conventionally amounts to less than 0.3 wt. %. In the case of the present soap bars with a low content of fatty acid soaps, it has been found that the service characteristics of the soap bars, in particular the hardness and solidification properties of the soap mass as it passes through the manufacturing process, improve substantially as the salt content increases. Relative to the total weight of the soap bar, a salt content of 0.3 to 2.5 wt. %, preferably of 0.35 to 2.0 wt. %, more preferably of 0.4 to 2.0 wt. %, particularly preferably of 0.45 to 1.8 wt. %, highly preferably of 0.5 to 1.5 wt. % is therefore according to the invention.

Deodorant active substances which may be considered are, for instance, antiperspirants such as for instance aluminum chlorohydrates. These are colorless, hygroscopic crystals which readily deliquesce in air and arise on evaporation of aqueous aluminum chloride solutions. Aluminum chlorohydrate is used to produce antiperspirant and deodorizing preparations and probably acts by partially closing the sweat glands by protein and/or polysaccharide precipitation [cf. J. Soc. Cosm. Chem. 24, 281 (1973)]. An aluminum chlorohydrate which is of formula [Al₂(OH)₅Cl]*2.5 H₂O and the use of which is more preferred is commercially obtainable from Hoechst AG, Frankfurt, Federal Republic of Germany under the trademark Locron® [cf. J. Pharm. Pharmacol. 26, 531 (1975)]. In addition to the chlorohydrates, aluminum hydroxylactates and acidic aluminum/zirconium salts may also be used. Esterase inhibitors may be added as deodorant active substances. These are preferably trialkyl citrates such as trimethyl citrate, tripropyl citrate, triisopropyl citrate, tributyl citrate and in particular triethyl citrate (Hydagen® CAT, Henkel KGaA, Düsseldorf, Federal Republic of Germany). These substances inhibit enzyme activity and so reduce odor formation. Cleavage of the citric acid ester probably here results in release of the free acid which reduces the pH value on the skin to such an extent that the enzymes are inhibited thereby. Further substances which may be considered as esterase inhibitors are dicarboxylic acids and the esters thereof, such as for example glutaric acid, glutaric acid monoethyl ester, glutaric acid diethyl ester, adipic acid, adipic acid monoethyl ester, adipic acid diethyl ester, malonic acid and malonic acid diethyl ester, hydroxycarboxylic acids and the esters thereof such as for example citric acid, malic acid, tartaric acid or tartaric acid diethyl ester. Antibacterial active substances which have an influence on microbial flora and kill or inhibit the growth of perspiration-decomposing bacteria may likewise be present in the soap bars. Examples of these are chitosan, phenoxyethanol and chlorhexidine gluconate. 5-Chloro-2-(2,4-dichlorophenoxy)-phenol, which is distributed by Ciba-Geigy, Basel (CH) under the trademark Irgasan®, has also proven particularly effective.

Hydrotropes, such as for example ethanol, isopropyl alcohol, or polyols may furthermore be used to improve processability. Polyols which may be considered here preferably have 2 to 15 carbon atoms and at least two hydroxyl groups. Many of the compounds already described among the polyhydroxy compounds may, of course, also be used as hydrotropes. Typical examples are
glycerol;
   alkylene glycols, such as for example ethylene glycol, diethylene glycol, propylene glycol, butylene glycol, hexylene glycol and polyethylene glycol with an average molecular weight of 100 to 1,000 dalton;
technical oligoglycerol mixtures with a degree of self-condensation of 1.5 to 10 such as for instance technical diglycerol mixtures with a diglycerol content of 40 to 50 wt. %;
methylol compounds, such as in particular trimethylolethane, trimethylolpropane, trimethylolbutane, pentaerythritol and dipentaerythritol;
lower alkyl glucosides, in particular those with 1 to 8 carbons in the alkyl residue, such as for example methyl and butyl glucoside;
sugar alcohols with 5 to 12 carbon atoms, such as for example sorbitol or mannitol,
sugars with 5 to 12 carbon atoms, such as for example glucose or sucrose;
amino sugars, such as for example glucamine.

Suitable preservatives are for example phenoxyethanol, formaldehyde solution, parabens, pentanediol or sorbic acid and the further classes of substances listed in Annex 6, parts A and B of the Cosmetics Directive. Pigments which may be considered are finely dispersed metal oxides or salts. Examples of suitable metal oxides are in particular zinc oxide and titanium dioxide and also oxides of iron, zirconium, silicon, manganese, aluminum and cerium and mixtures thereof.

Perfume oils which may be mentioned are mixtures of natural and synthetic odorants. Natural odorants are extracts of blossoms (lily, lavender, rose, jasmine, neroli, ylang-ylang), stems and leaves (geranium, patchouli, petitgrain), fruits (aniseed, coriander, caraway, juniper), fruit peels (bergamot, lemon, orange), roots (mace, angelica, celery, cardamom, costus, iris, calamus), woods (pine, sandalwood, guaiacwood, cedar, rosewood), herbs and grasses (tarragon, lemongrass, sage, thyme), needles and branches (spruce, fir, pine, mountain pine), resins and balsams (galbanum, elemi, benzoin, myrrh, olibanum, opoponax). Animal raw materials may also be considered, such as for example civet and castoreum. Typical synthetic odorant compounds are products of the ester, ether, aldehyde, ketone, alcohol and hydrocarbon types. Odorant compounds of the ester type are for example benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. Ethers include, for example, benzyl ethyl ether, the aldehydes include, for example, linear alkanals with 8 to 18 carbon atoms, citral, citronellal, citronellyloxyacetaldehyde, cyclamen aldehyde, hydroxycitronellal, lilial and bourgeonal, ketones include, for example, ionones, α-isomethylionone and methyl cedryl ketone, alcohols include anethole, citronellol, eugenol, isoeugenol, geraniol, linalool, phenylethyl alcohol and terpineol, the hydrocarbons mainly include terpenes and balsams. Preferably, however, mixtures of various odorants are used which together produce an attractive scent note. Relatively low volatility essential oils, which are generally used as aroma components, are also suitable as perfume oils, for example sage oil, chamomile oil, clove oil, melissa oil, mint oil, cinnamon leaf oil, lime blossom oil, juniper berry oil, vetiver oil, olibanum oil, galbanum oil, labdanum oil and lavandin oil. Preferably, bergamot oil, dihydromyrcenol, lilial, lyral, citronellol, phenylethyl alcohol, α-hexylcinnamaldehyde, geraniol, benzyl acetone, cyclamen aldehyde, linalool, Boisambrene Forte, ambroxan, indole, hedione, sandelice, lemon oil, mandarin oil, orange oil, allyl amyl glycolate, cyclovertal, lavandin oil, muscatel sage oil, β-damascone, Bourbon geranium oil, cyclohexyl salicylate, Vertofix Coeur, Iso E Super, Fixolide NP, evernyl, iraldein gamma, phenylacetic acid, geranyl acetate, benzyl acetate, rose oxide, romillate, irotyl and floramate are used alone or in mixtures.

Further examples of odorants present in the perfume oils for the soap bars according to the invention are to be found for example in S. Arctander, Perfume and Flavor Materials, Vols. I and II, Montclair, N.J., 1969, self-publication or K. Bauer, D. Garbe and H. Surburg, Common Fragrance and Flavor Materials, 3th ed., Wiley-VCH, Weinheim 1997.

The perfume oils are generally added to the soap base in a quantity of 0.05 to 5 wt. %, preferably of 0.1 to 2.5 wt. %, more preferably of 0.2 to 1.5 wt. %, relative to the soap base.

The perfume oils may be added to the soap base for perfuming purposes in liquid form, undiluted or diluted with a solvent. Solvents suitable for this purpose are for example ethanol, isopropanol, diethylene glycol monoethyl ether, glycerol, propylene glycol, 1,2-butylene glycol, dipropylene glycol, diethyl phthalate, triethyl citrate, isopropyl myristate etc.

Moreover, the perfumes for the compositions according to the invention may be adsorbed on a carrier material, which ensures both fine distribution of the odorants in the product and controlled release during use. Such carriers may be porous inorganic materials such as light sulfate, silica gels, zeolites, gypsums, clays, clay granules, aerated concrete etc. or organic materials such as woods and cellulose-based substances.

The perfume oils for the soap bars may also be microencapsulated, spray-dried or present as inclusion complexes or extrusion products and added in this form to the soap base to be perfumed.

Optionally, the properties of the perfume oils modified in this way may be further optimized with regard to more targeted scent release by “coating” with suitable materials, for which purpose waxy plastics such as for example polyvinyl alcohol are preferably used.

Dyes which may be used for coloring the compositions are those approved substances suitable for cosmetic purposes, as are for example compiled in the publication “Kosmetische Färbemittel” [cosmetic coloring agents] from the dyestuffs committee of DFG, the German Research Foundation, Verlag Chemie, Weinheim, 1984, pages 81-106. These dyes are conventionally used in concentrations of from 0.001 to 0.1 wt. %, relative to the total mixture.

The pH value of the soap bars according to the invention is preferably in a range from 5 to 11, more preferably from 6 to 11 and highly preferably from 7 to 10. Virtually any acid or base usable for cosmetic purposes may be used to adjust the pH value. Preferred bases are ammonia, alkali metal hydroxides, monoethanolamine, triethanolamine and N,N,N′,N′-tetrakis-(2-hydroxypropyl)-ethylenediamine.

Edible acids are conventionally used as acids. Edible acids are taken to mean such acids which are consumed within the context of conventional food intake and have a positive effect on the human body. Edible acids are for example acetic acid, lactic acid, malonic acid, fumaric acid, tartaric acid, citric acid, malic acid, ascorbic acid and gluconic acid. It is more preferred for the purposes of the invention to use citric acid, tartaric acid and lactic acid.

Further active substances, auxiliary substances and additives are for example
cosmetic ingredients for the multiphase soaps according to the invention are known per se (Soaps and Detergents, Luis Spitz, ISBN 0-935315-72-1 and Production of Toilet Soap, D. Osterath, ISBN 3-921956-55-2).
thickeners such as agar-agar, guar gum, alginates, xanthan gum, gum arabic, karaya gum, locust bean flour, linseed gums, dextrans, cellulose derivatives, for example methylcellulose, hydroxyalkylcellulose and carboxymethylcellulose, starch fractions and derivatives such as amylose, amylopectin and dextrins, clays such as for example bentonite or completely synthetic hydrocolloids such as for example polyvinyl alcohol,
dimethyl isosorbide and cyclodextrins,
antidandruff active substances such as piroctone olamine, zinc omadine and climbazole,
active substances such as allantoin and bisabolol,
complexing agents such as EDTA, NTA, β-alaninediacetic acid, iminodisuccinic acid and the salts thereof as well as phosphonic acids,
swelling and penetrating substances such as primary, secondary and tertiary phosphates,
opacifiers such as latex, styrene/PVP and styrene/acrylamide copolymers
pearlescent agents such as ethylene glycol mono- and distearate as well as PEG-3 distearate,
pigments,
antioxidants,
menthol and menthol derivatives,
warming active substances such as for example capsaicin.

Water may also be present in the soap masses according to the invention. Quantities of 0.1 to 20.0 wt. %, preferably 1 to 20.0 wt. %, more preferably 3 to 18 wt. %, particularly preferably 7 to 18 wt. % and highly preferably 10 to 18 wt. % water, in each case relative to the total weight of the soap bar, may be present.

With regard to further optional components and the quantities used of these components, explicit reference is made to the relevant manuals known to a person skilled in the art, for example the above-stated monograph by K. H. Schräder or the monographs “Soaps and Detergents”, Luis Spitz, ISBN 0-935315-71-2 and “Production of Toilet Soap”, D. Osterath, ISBN 3-921956-55-2.

The soap bars according to the invention may be produced in the manner conventional for such products, wherein in particular due to the combination according to the invention a particularly readily shapeable mass which is sufficiently plastic, but not rubber-elastic, when hot and is hard once cool and wherein the shaped products have a smooth surface. Conventional methods for mixing or homogenizing, kneading, optionally milling, extruding, optionally pelletizing, extrusion, cutting and bar pressing are familiar to a person skilled in the art and may be used for producing the soap bars according to the invention. Production preferably proceeds in the temperature range from 40 to 90° C., wherein the fusible ingredients are initially introduced into a heatable kneader or mixer and the non-fusible components are stirred in. The mixture may then be homogenized by being passed through a screen, after which shaping is performed. In a preferred embodiment of the invention, the components are used in anhydrous, granular form, as they are obtained after drying in a “flash dryer”. Reference is made in this connection to the teaching of German patent DE-C1 19534371.

Shaped soap products for the purposes of the invention may, however, also be in the form of noodles, needles, granules, extrudates, flakes and any other shape conventional for soap products.

The soap bars according to the invention may furthermore obtain a marbled appearance for example by injecting dye solutions during extrusion.

The soap bars according to the invention may likewise be processed as multiphase soaps, in particular as a soap bar also provided with a conditioning phase. A person skilled in the art is aware of numerous possibilities to this end, such as for example adhesively bonding the soap phase to the conditioning phase, but also further possibilities such as coextruding the soap and conditioning phases.

Finally, the soap bars according to the invention may even exhibit a certain degree of transparency. Particularly finely divided inorganic components are selected for this purpose. At least semi-transparent soaps may then be obtained.

The soap bars according to the invention are distinguished by a particularly smooth surface. In use, a copious creamy lather with fine bubbles is formed. While lime soap precipitates are indeed formed in hard water, they remain dispersed in the solution and are not deposited on hard surfaces as greasy gray stains or a pasty ring, but instead at most as a slight, finely divided film.

The following examples are intended to illustrate the subject matter of the invention in greater detail:

### EXAMPLES

All values are stated in wt. % and INCI nomenclature is used for the ingredients.

| | S1 | S2 | S3 | S4 | S5 | S6 | S7 |
|---|---|---|---|---|---|---|---|
| Sodium Palm Stearate | 7.0 | 9.0 | — | — | — | 10.0 | — |
| Sodium Palmate | 29.0 | 31.0 | — | — | — | 30.0 | — |
| Sodium Tallowate | — | — | 34.0 | — | 20.0 | — | 30.0 |
| Sodium Cocoate | 6.0 | — | 6.0 | — | 6.0 | — | 12.0 |
| Sodium Olivate | — | — | — | 45.0 | — | — | — |
| Sodium Palm | — | — | — | — | — | 6.0 | — |
| Kernelate | | | | | | | |
| Sodium Lardate | — | — | — | — | 20.0 | — | — |
| Coconut Oil | — | 7.0 | — | — | — | — | — |
| Coconut Acid | — | — | 1.0 | — | — | — | — |
| Tallow Acid | — | — | 1.0 | — | — | — | — |
| Talc | 25.0 | 20.4 | 25.0 | 20.0 | 21.0 | 21.0 | 25.0 |
| Corn Starch | 5.4 | 2.0 | — | 6.0 | 5.4 | 5.0 | — |
| Wheat Starch | — | — | 5.0 | — | — | — | 5.4 |
| Sodium Silicate | 4.0 | 4.0 | 5.0 | 5.0 | 4.0 | 4.0 | 4.0 |
| Sodium Lauryl Sulfate | 4.6 | 4.0 | 4.0 | — | 4.6 | 4.6 | — |
| Sodium Laureth | — | — | — | — | — | — | 4.6 |
| Sulfate | | | | | | | |
| Cocamidopropyl | — | — | — | 4.0 | — | — | — |
| Betaine | | | | | | | |
| Decyl Glucoside | — | — | — | — | — | — | — |
| Water | 13.0 | 14.0 | 13.07 | 14.0 | 13.0 | 12.9 | 13.0 |
| Glycerol | 4.5 | 5.1 | 4.5 | 5.1 | 4.5 | 4.5 | 4.5 |
| Perfume | 1.2 | 1.3 | 1.0 | 0.5 | 1.2 | 1.2 | 1.2 |
| Tetrasodium EDTA | 0.1 | 0.1 | 0.1 | 0.1 | 0.1 | 0.1 | 0.1 |
| Tetrasodium | 0.1 | 0.1 | 0.1 | 0.1 | 0.1 | 0.1 | 0.1 |
| Etidronate | | | | | | | |
| Titanium Dioxide | 0.1 | — | 0.2 | 0.2 | 0.1 | 0.1 | 0.1 |
| Sodium Lactate | — | — | — | — | — | 0.5 | — |
| CI 11680 | — | — | 0.03 | — | — | — | — |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A soap bar, which comprises, in each case relative to the total weight of the soap bar,
a) fatty acid soaps in a total quantity of 20 to 60 wt. %,
b) talcum in a total quantity of 3 to 40 wt. %,
c) one or more silicates in a total quantity of 0.5 to 30 wt. %,
d) one or more synthetic surfactants, selected from anionic, amphoteric, zwitterionic, nonionic and/or cationic surfactants in a total quantity of 0.1 to 20.0 wt. %, and
e) starch in a total quantity of 0.1 to 10.0 wt. %.

2. The soap bar according to claim 1, wherein the one or more synthetic surfactants is/are selected from anionic, amphoteric, zwitterionic and/or nonionic surfactants.

3. The soap bar according to claim 2, wherein the one or more synthetic surfactants is/are anionic surfactants.

4. The soap bar according to claim 3, wherein the anionic surfactant(s) is/are selected from the group consisting of:
acyl sarcosides with 8 to 24 C atoms in the acyl group,
ether carboxylic acids of formula R—O—(CH₂—CH₂O)ₓ—CH₂—COOH, in which R is a linear alkyl group with 8 to 30 C atoms and x=0 or 1 to 16 and the salts thereof, acyl taurides with 8 to 24 C atoms in the acyl group, acyl isethionates with 8 to 24 C atoms in the acyl group,
alkyl sulfates and alkyl polyglycol ether sulfates of formula R—O(CH₂—CH₂O)ₓ—OSO₃H, in which R is a preferably linear alkyl group with 8 to 30 C atoms and x=0 or 1 to 12,
alkyl and/or alkenyl ether phosphates of formula R¹(OCH₂CH₂)ₙ—O—(PO—OX)—OR², in which R¹ preferably denotes an aliphatic hydrocarbon residue with 8 to 30 carbon atoms, R² denotes hydrogen, a residue (CH₂CH₂O)ₙR² or X, n denotes numbers from 1 to 10 and X denotes hydrogen, an alkali metal or alkaline earth metal or NR³R⁴R⁵R⁶, with R³ to R⁶ mutually independently denoting hydrogen or a C₁ to C₄ hydrocarbon residue,
monoglyceride sulfates and monoglyceride ether sulfates of formula R⁸OC—(OCH₂CH₂)ₓ—OCH₂-[CHO(CH₂CH₂O)_{y}H]—CH₂O(CH₂CH₂O)_{z}—SO₃X, in which R⁸CO denotes a linear or branched acyl residue with 6 to 22 carbon atoms, x, y and z in total denote 0 or numbers from 1 to 30, preferably 2 to 10, and X denotes an alkali metal or alkaline earth metal,
acyl glutamates of formula XOOC—CH₂CH₂CH(C(NH)OR)—COOX, in which RCO denotes a linear or branched acyl residue with 6 to 22 carbon atoms and 0 and/or 1, 2 or 3 double bonds and X denotes hydrogen, an alkali metal and/or alkaline earth metal, ammonium, alkylammonium, alkanolammonium or glucammonium, and condensation products of a water-soluble salt of a water-soluble protein hydrolysate with a C₈-C₃₀ fatty acid, and mixtures thereof.

5. The soap bar according to claim 1, wherein the soap bar includes at least one alkyl oligoglucoside.

6. The soap bar according to claim 1, wherein the soap bar includes at least one amphoteric and/or zwitterionic surfactant.

7. The soap bar according to claims 1, wherein a mixture of tallow fatty acid soap and coconut fatty acid soap is used as the fatty acid soap.

8. The soap bar according to claim 7, wherein the mixture of fatty acid soaps includes 50-80 wt. % tallow fatty acid soap and 20-50 wt. % coconut fatty acid soap.

9. The soap bar according to claim 1, further comprising 0.1 to 20.0 wt. % water.

10. The soap bar according to claim 1, wherein, in relation to the total weight of the soap bar, 0.01 to 10.0 wt. % of free fatty acid is included.
